(19) United States
(12) Patent Application Publication
(10) Pub. No.: US 2024/0401324 A1
(43) Pub. Date: Dec. 5, 2024

(54) A SET OF STRUCTURAL PANELS, A PRODUCTION METHOD, AND AN ASSEMBLY METHOD

(71) Applicant: MODITRI AB, Lerberget (SE)

(72) Inventor: Markus BERGELIN, Lerberget (SE)

(21) Appl. No.: 18/689,206

(22) PCT Filed: Sep. 1, 2022
(86) PCT No.: PCT/EP2022/074348

§ 371 Date: Mar. 5, 2024

(30) Foreign Application Priority Data
Sep. 6, 2021 (SE) 2151108-4

(51) Int. Cl. E04B 1/14; E04B 1/08; E04B 1/10; E04B 1/61

(52) U.S. Cl. CPC E04B 1/14; E04B 1/08; E04B 1/10; E04B 1/6179

(57) ABSTRACT

A set of structural panels comprising a first structural panel (10′), a second structural panel (10″) and a mechanical locking system (30), wherein the mechanical locking system comprises: a first locking member (31) arranged at an edge of the first structural panel (10′) and comprising at least two layers of a load bearing laminate of layers (20) of the first structural panel (10′); a second locking member (32) arranged at an edge of the second structural panel (10″) and comprising at least two layers of a load bearing laminate of layers of the second structural panel (10″); wherein the mechanical locking system is configured to form an unlocked disposition (40) and a locked disposition (41), wherein the mechanical locking system is configured to connect the first structural panel (10′) to the second structural panel (10″) by a rotational movement of the second structural panel (10″) in relation to the first structural panel (10′), the rotational movement going from the unlocked disposition to the locked disposition (41).

### TECHNICAL FIELD

The present inventive concept relates, in general, to structural panels in buildings. In particular, the present inventive concept relates to a set of structural panels.

### BACKGROUND

A building comprise structural members configured to provide structural integrity to the building. The structural members may e.g. serve to keep the building upright and to hold the building together under a load. The load may e.g. be the weight of the building itself, additionally/alternatively the load may be an environmental load (e.g. from wind), a foundation settlement, etc. Structural panels may, separately or jointly, form a structural member of a building. Thus, a structural panel may contribute to the structural integrity of a building. Structural panels may e.g. be made of concrete or cross-laminated timber (CLT). Several structural panels may together form a part of a building, such as a subfloor or a wall, e.g. a bearing wall.

### SUMMARY

It is an objective of the present inventive concept to provide structural panels which are environmentally friendly. It is a further objective of the present inventive concept to provide structural panels which are cost-effective, and/or facilitate an efficient building process. These and other objectives of the inventive concept are at least partly met by the invention as defined in the independent claims. Preferred embodiments are set out in the dependent claims.

According to a first aspect, there is provided a set of structural panels comprising a first structural panel, a second structural panel and a mechanical locking system,
wherein each of the first and second structural panel:
   is configured to contribute to the structural integrity of the building;
   extend in a plane;
   comprise an edge extending in an edge direction;
   comprise a load bearing laminate of layers, the load bearing laminate of layers being a laminate of layers configured to bear at least part of a structural load of the building, the load bearing laminate of layers comprising wood;
wherein the mechanical locking system comprises:
   a first locking member arranged at the edge of the first structural panel and comprising at least two layers of the load bearing laminate of layers of the first structural panel;
   a second locking member arranged at the edge of the second structural panel and comprising at least two layers of the load bearing laminate of layers of the second structural panel;
wherein the mechanical locking system is configured to form:
   an unlocked disposition, wherein the first and second locking members of the mechanical locking system are in contact, with the plane of the second structural panel being at an angle to the plane of the first structural panel and the second structural panel being rotationally movable in relation to the first structural panel;
   a locked disposition, wherein the first and second locking members of the mechanical locking system are in contact, with the plane of the second structural panel being aligned to the plane of the first structural panel and the first and second locking members of the mechanical locking system being interlocked to prevent separating movements of the first and second structural panels in at least one direction orthogonal to the aligned planes of the first and second structural panels, and one direction within the aligned planes of the first and second structural panels,
   wherein the mechanical locking system is configured to connect the first structural panel to the second structural panel by a rotational movement of the second structural panel in relation to the first structural panel, the rotational movement going from the unlocked disposition to the locked disposition.

The set of structural panels are environmentally friendly. For example, it may have a small CO2 footprint as wood is a renewable material. Wood may therefore be more environmentally friendly than e.g. concrete. CLT structural panels, which comprise wood, are used in the building industry. However, it is a realization that further improvements may be achieved. For example, CLT structural panels are often connected to each other by screws made of steel. It is a realization that said screws have a non-negligible impact on the overall CO2 footprint of the building. As the first and second structural panel may be connected to each other by the mechanical locking system, little steel (e.g. few screws or no screws) may be needed.

Further, the set of structural panels facilitate an efficient building process. The first and second structural panel may be connected to each other quickly by the rotational movement from the unlocked disposition to the locked disposition of the mechanical locking system. It may e.g. be quicker to connect structural panels by a rotational movement than screwing them together.

The set of structural panels may be seen as having similarities to click-lock laminate floor panels for floating floors. Such laminate floor panels may also connect to each other by a rotational movement when installed by hand.

It is a realization that even though structural panels generally are heavy, large and need to be handled by a crane, it is indeed possible to perform a rotational movement by a crane or similar lifting machine and thereby connecting the structural panels. This becomes evident when considering the third aspect below. It is indeed possible to perform such a rotational movement by a crane or similar lifting machine at a speed that is superior to screwing structural panels together.

Further, the set of structural panels facilitate a cost-effective building process. Savings may be made in labor costs due to the speed at which the structural panels may be connected. Additionally, or alternatively, savings may be made in material costs as the need for other connection means (e.g. screws, nails, brackets etc.) may be low when the set of structural panels is used.

It should be understood that the use of the set of structural panels with its mechanical locking system does not exclude other connection means (e.g. screws, nails, brackets etc.). Such other connection means may be used as a complement to the mechanical locking system.

The structural panels connected by the mechanical locking system, as described above and below, may be seen as structural panels with a rotational mechanical locking system.

It should be understood that some features discussed may have advantages also for structural panels with a non-rotational mechanical locking system. The applicant reserves the right to file divisional applications on such features in other contexts than rotational mechanical locking systems, e.g. in the context of a non-rotational mechanical locking system.

It should be understood that some features discussed may have advantages also for non-structural panels with a rotational mechanical locking system, such as e.g. click-lock laminate floor panels for floating floors. The applicant reserves the right to file divisional applications on such features in other contexts than structural panels, e.g. in the context of click-lock laminate floor panels for floating floors.

A structural panel according to the first aspect, such as each of, or either of, the first and second structural panel, may be made entirely of the load bearing laminate of layers. Alternatively, said structural panel may, in addition to the load bearing laminate of layers, comprise other components, e.g. layers for aesthetic purposes.

A structural panel according to the first aspect, such as each of, or either of, the first and second structural panel, may have a rectangular shape. The structural panel may have four edges. Said four edges may form the rectangular shape. The locking member of a structural panel may be arranged at one of the four edges defining a rectangular structural panel.

A structural panel may comprise two locking members, e.g. a first locking member at one edge and a second locking member at another edge. Such a structural panel may be termed a dual use structural panel, it may be used as either a first structural panel or a second structural panel. A dual use structural panel may comprise a first locking member at a first edge and a second locking member at a second edge, wherein the first and second edge are opposite to each other. Thus, by connecting such structural panels in a row, wherein each structural panel connects to a succeeding structural panel by the first locking member and connects to the preceding structural panel by the second locking member, or vice versa, the row of structural panels may form a larger structure, e.g. form a wall or a floor of a building. Further, the two locking members may be arranged on opposite sides, e.g. at opposite edges, of the structural panel. Additionally, there may be more locking members. For example, locking members along one or more edges which are orthogonal to said opposite edges. Further, there may be one or more locking member on the top surface or on the bottom surface of the structural panel. A lock at an orthogonal edge may be configured as a first or second locking member. Alternatively, a lock at an orthogonal edge may be configured differently, e.g. to lock two structural panels together orthogonally to each other.

The load bearing laminate of layers comprises wood but may additionally comprise other materials, e.g. adhesive gluing the layers together. Each layer of the load bearing laminate of layers may comprise wood. This may be advantageous as it may be environmentally friendly. However, it is possible to conceive embodiments where one or more layers do not comprise wood. The load bearing laminate of layers may comprise Cross-Laminated Timber, in short CLT. Each layer of the CLT may comprise solid wood members, such as lumber boards, arranged side by side in parallel. All solid wood members within a layer may have the same wood fiber direction. The wood fiber direction of neighboring layers of the CLT may be orthogonal to each other. The load bearing laminate of layers may comprise layers of chip board or oriented strand board. For example, each layer of the load bearing laminate of layers may be a chip board or each layer of the load bearing laminate of layers may be an oriented strand board. The load bearing laminate of layers may comprise laminated veneer lumber/LVL. Layers of different material may be combined, e.g. one layer of wood lumber and one of oriented chip board or LVL,

The load bearing laminate of layers of a structural panel, such as the first or second structural panel may comprise wood fibers extending in two orthogonal directions. The load bearing laminate of layers may comprise one layer with wood fibers mainly in one direction and another layer with wood fibers mainly in a direction orthogonal to said one direction. This may be the case e.g. for a CLT structural panel. However, it may also be the case for a structural panel wherein one layer is e.g. a oriented strand board with a main fiber direction in one direction and another layer is another oriented strand board with a main fiber direction in a direction orthogonal to said one direction.

The mechanical locking system is configured such that, in the locked disposition, the first and second locking members are interlocked to prevent separating movements of the first and second structural panels in at least one direction orthogonal to the aligned planes of the first and second structural panels, and one direction within the aligned planes of the first and second structural panels. For example, the mechanical locking system may be configured to firstly prevent the first and second structural panels from moving away from each other in a direction within the aligned planes of the first and second structural panels and orthogonal to the edges of the locking members of the first and second structural panels; and secondly prevent the first and second structural panels from moving away from each other in one direction orthogonal to the aligned planes of the first and second structural panels. In the application this is also referred to as the vertical direction and vertical locking. A mechanical locking system configured to prevent the first and second structural panels from moving away from each other in one direction orthogonal to the aligned planes of the first and second structural panels may be configured to prevent movements in both directions orthogonal to the aligned planes of the first and second structural panels e.g. prevent both upwards and downwards movements of one of the structural panels with respect to the other. Further, the mechanical locking system may be configured for shear locking. For example, a vertical lock and/or a horizontal lock may comprise press fit, meaning that the second locking member is larger than the cavity in the first member that shall hold the second member. Shear locking embodied in other ways are further described below. In the embodiments in this application, press fit engagement may also be achieved by sectional press fit along the edge of the interlocked locking members. One interlocked cross section may have press fit whereas a second cross section along the interlocked edges may not have press fit. The vertical lock may also be loose, comprising a tongue of the first locking element which is vertically thinner than the tongue groove of the first locking member. There may be a vertical gap between a vertical locking surface of the first locking member and an opposite vertical locking member of the second locking member in the connected disposition. The loose vertical fit may be partial or along the entire connected edges.

The mechanical locking system may be configured to, in the locked disposition, transfer part of a structural load borne by the load bearing laminate of layers of one of the first and second structural panels to the other of the first and second structural panels.

The mechanical locking system may be configured to, in the locked disposition, resist a first and a second force, wherein
the first force is a force acting to separate the first and second structural panel in a direction orthogonal to the aligned planes of the first and second structural panels; and
the second force is a force acting to separate the first and second structural panel in a direction within the aligned planes of the first and second structural panels and orthogonal to the edge directions of the edges of the first and second structural panels at which the respective first and second locking members are arranged. The first and/or second force may herein be associated with a structural load of the building. In the application this is also referred to as the horizontal direction and horizontal locking.

The first locking member may comprise an upper lip and a lower lip, being respective protrusions of the load bearing laminate of layers associated with the locking member. The upper and lower lip may e.g. respectively protrude in a direction orthogonal both to the normal of the plane of the panel associated with the locking member and to the edge direction associated with the locking member. The lower lip may protrude more than the upper lip. Such an arrangement may facilitate effective interlocking between the first and second locking member. The upper lip may, in the locked disposition, prevent the second locking member from moving upwards. The lower lip may, in the locked disposition, prevent the second locking member from moving downwards. A lower lip that protrudes more than the upper lip may facilitate the second structural panel coming in from above, at an angle to the first structural panel, and interlock by the rotational movement. Thus, such an arrangement may facilitate an effective interlocking between the first and second structural panels. In the following the principle will be exemplified.

The set of structural panels may be configured such that:
the first locking member comprises
   an upper lip and a lower lip, being respective protrusions of the load bearing laminate of layers of the first structural panel at the edge of the first structural panel, in a direction orthogonal both to the normal of the plane of the first structural panel and to the edge direction of the first structural panel, the lower lip being arranged below the upper lip;
   a tongue groove, being a recess into the load bearing laminate of layers of the first structural panel at the edge of the first structural panel, the tongue groove being arranged between the upper and lower lip; and
the second locking member comprises a tongue, the tongue being a protrusion of the load bearing laminate of layers of the second structural panel at the edge of the second structural panel, in a direction orthogonal both to the normal of the plane of the second structural panel and to the edge direction of the second structural panel,
   wherein the second locking member is configured to insert at least a part of said tongue into said tongue groove by the rotational movement of the second structural panel in relation to the first structural panel.

Thus, when the tongue is inserted into the tongue groove, the tongue may be prevented from moving upwards by the upper lip and prevented from moving downwards by the lower lip. Such a configuration may be seen as the tongue and the tongue groove extending in a horizontal direction. However, it should be understood that, as an alternative, the tongue and the tongue groove may extend in a vertical direction.

The first locking member may be configured such that a length of the lower lip, from the innermost part of the tongue groove to the outermost part of the lower lip, is greater than a thickness of the first structural panel.

The first locking member may be configured such that a distance that the lower lip extends beyond the upper lip is greater than a thickness of the first structural panel. This may be advantageous for an over-angled locking system (see description below). The distance may be shorter for un under-angled locking system.

Further, the upper lip may have a contact plane, wherein the contact plane is orthogonal to the plane of the first structural panel and comprises the outermost contact point of the upper lip to the second locking member. The contact plane may be at an angle to the plane of the first panel. It may be curved.

The tongue comprises:
an upper locking surface configured to, when in contact with the upper lip of the first locking member, prevent separating movements of the first and second structural panels in at least one direction orthogonal to the aligned planes of the first and second structural panels; and
a lower locking surface configured to, when in contact with the lower lip of the first locking member, prevent separating movements of the first and second structural panels in at least one direction orthogonal to the aligned planes of the first and second structural panels.

According to one aspect, the tongue is the part of the second structural panel, at the edge, where the thickness is not the full thickness of the load bearing laminate of layers.

The set of structural panels may be configured such that the first locking member comprises a protruding locking element and the second locking member comprises a locking groove or vice versa,
wherein the locking element is configured to engage the locking groove to prevent separating movements of the first (10′) and second (10″) structural panels in one direction within the aligned planes of the first (10′) and second (10″) structural panels.

The locking element and the locking groove may e.g. be configured to prevent movements in a direction (within the aligned planes) orthogonal to the edge and/or movements in a direction (within the aligned planes) along the edge.

As an example of a configuration comprising a locking element and a locking groove, consider the following: the set of structural panels may be configured such that:
the first locking member further comprises:
   a locking element, the locking element being a protrusion of the lower lip, in a direction normal to the plane of the first structural panel; and
the second locking member further comprises:
   a locking groove, the locking groove being a recess into the load bearing laminate of layers of the second structural panel at the lateral side of the second structural panel, in a direction normal to the plane of the second structural panel,
wherein said lower lip is configured to insert said locking element into said locking groove, by the rotational movement of the second structural panel in relation to the first structural panel.

In the above description and below, the position of the locking element and locking groove may be shifted. The locking element may protrude from the tongue of the second locking member. The locking groove may be a recess in the first locking member.

Thus, when the locking element is inserted into the locking groove, the locking element may be prevented, by the locking groove, from moving in a direction within the aligned planes of the first and second structural panels.

The locking element may extend along the entire edge. Such a locking element configuration may prevent movements orthogonal to the edge. Alternatively, there may be several separate locking elements with spaces between, wherein the separate locking elements with spaces between are arranged along the edge. Such a locking element configuration may prevent movements orthogonal to the edge as well as movements along the edge. Such locking element configuration may be described as a plurality of locking elements. The locking groove may be provided with protrusions that fit between the locking elements. The protrusions may be separate locking element material, alternatively they may be integrally formed in the load bearing laminate of layers. This may prevent longitudinal movement along the edge. Below referred to as shear forces. The locking element may extend from the tongue, forming a tongue protrusion. It may extend from a groove of the second locking member. It may extend at the lower side of the tongue. When extending from the tongue in a direction orthogonal to the edge, it may in the interlocked state of the panels be inserted in the space between two separate locking elements that are provided along the lower lip on the lower lip of the first locking member. The locking elements of the first locking member may extend from a locking groove.

In addition to the first and second locking members the mechanical locking system of the set of structural panels may comprise
a third locking member configured to, in the locked disposition of the mechanical locking system, resist a shear force,
   wherein the shear force is a force acting to separate the first and second structural panel in a direction parallel to the edge directions of the edges of the first and second structural panels at which the respective first and second locking members are arranged. It should be understood that, as described above, parts of the first and second locking member may act in addition as a third locking member.

Resisting shear forces may be particularly important for structural panels contributing to the structural integrity of the building. In contrast, a floating floor may not need to resist shear forces to a similar extent as these forces may be small when the floor is not connected to the rest of the building.

It should be understood that the third locking member may have advantages also for structural panels with a non-rotational mechanical locking system. For example, a CLT structural panel, e.g. a CLT floor or wall structural panel, with a non-rotational mechanical locking system may advantageously be used together with a third locking member. It may be provided in the groove and the tongue of e.g. embodiment in FIG. 29A. The embodiment may be provided with equivalent third locking features as for the rotational locking described below. For example, it will also in this embodiment be obscured from sight and it may have guiding chamfers. It will be advantageous for wall panels especially. The panels may be configured to be installed by shifting the panels relative each other in a common aligned plane. They may be shifted in an orthogonal direction the interlocked edges. The upper lip and the lower lip of the first panel may be of essentially equal length as a tongue and groove connection system. The third locking element may lock in a direction along the interlocked edges.

It should be understood that the third locking member may have advantages also for non-structural panels with a rotational mechanical locking system. For example, a click-lock laminate floor panel comprising a third locking member may have advantages. The applicant reserves the right to file divisional applications relating to the third locking member (and any feature of the third locking member) in these contexts.

The third locking member may be configured to be obscured from sight by the first and second structural panels when the mechanical locking system is in the locked disposition. Thus, no extra work may be needed to obscure the third locking member once the mechanical locking system is in the locked disposition. This may facilitate an efficient building process.

The mechanical locking system may be configured to form a cavity between the first and second locking member when the mechanical locking system is in the locked disposition and wherein the third locking member is a unit separate from the first and second structural panel and configured to, when placed in the cavity between the first and second locking member, prevent the first and second locking member from moving relative to each other along the direction parallel to the edge directions of the edges of the first and second structural panels at which the respective first and second locking members are arranged. Side walls of the cavity may herein prevent lateral movements of the separate unit such that the separate unit is at least partially fixed just by being placed in the cavity. The cavity may e.g. be formed by an indentation in the first locking member and an indentation in the second locking member. The separate unit may then be e.g. a block, such as a wooden block, which is placed in the indentation of the first or second locking member. Once the first and second locking member are interlocked, the separate unit, e.g. the block, may fill at least part of the indentation in the first locking member and fill at least part of the indentation in the second locking member. This may prevent the first and second locking member from moving relative to each other along the edge direction.

The third locking member may be a truss connector plate, being a metal plate with protruding metal teeth, wherein the truss connector plate is configured to, when the metal plate is placed on one of the first or second locking members, insert the protruding metal teeth into the other of the first or second locking member by the rotational movement of the second structural panel in relation to the first structural panel. The teeth may protrude from the same side of the plate on.

The truss connector plate may be made of e.g. steel or aluminium. It may be of metal. As an alternative, the plate and teeth of the truss connector plate may be made of plastic instead of metal. The teeth of the truss connector plate may be flat and of the same thickness as the plate of the truss connector plate. The teeth may be aligned or in altering angles to each other. The truss connector plate may be used to interlock other objects than structural load bearing panels; for example beam to beam, beam to panel and indoor flooring panels.

When the truss connector plate is placed, it may also be connected to one of the first or second locking members. For example, the truss connector plate may be screwed to the first or second locking member. Once the protruding metal teeth has been inserted into the other of the first or second locking member, by the rotational movement, the truss connector plate may be restricted from moving relative to one locking member by the screw and relative to the other locking member by the metal teeth. Thus, the first and second locking members may be restricted from moving relative to each other by the truss connector plate. Alternatively, the truss connector plate may be a double sided truss connector plate. Such a double sided truss connector plate may have protruding metal teeth on both sides. When a double sided truss connector plate is placed on one of the first or second locking members, it may insert the protruding metal teeth on one side into the first locking member and the metal teeth on the other side into the second locking member, by the rotational movement of the second structural panel in relation to the first structural panel.

When the truss connector plate is placed, it may be placed in a cavity, such as an indentation, of one of the first or second locking members. The metal teeth may protrude out of the cavity. The other locking member may not have a corresponding cavity such that when the first and second locking members are interlocked by the rotational movement, the metal teeth protruding out of the cavity may be inserted into the other locking member. Once the protruding metal teeth has been inserted into the other of the first or second locking member, by the rotational movement, the truss connector plate may be restricted from moving relative to one locking member by side walls of the cavity and relative to the other locking member by the metal teeth. Thus, the first and second locking members may be restricted from moving relative to each other by the truss connector plate.

It should be understood that the cavity may be configured to prevent movements both in directions parallel to the edge directions of the edges of the first and second structural panels and in directions orthogonal to the edge directions of the edges of the first and second structural panels. This may be achieved with a double sided truss connector plate. This may, alternatively or additionally, be achieved with a cavity of similar size (e.g. slightly larger) as the truss connector plate in the orthogonal direction to the edge. This may, alternatively or additionally, be achieved by the truss connector plate, not counting the teeth, being thicker than the depth of the cavity. Alternatively, the cavity may be configured to prevent movements in directions parallel to the edge directions of the edges of the first and second structural panels but allow movements in directions orthogonal to the edge directions of the edges of the first and second structural panels. This may be achieved with a cavity which is larger (e.g. more than 5% larger, or more than 20% larger) than the truss connector plate in the direction orthogonal to the edge.

At least one of the first and second structural panel may comprise an attachment, wherein the attachment is configured such that the structural panel can be attached to a lifting arrangement and lifted by the lifting arrangement.

For example, at least one of the first and second structural panel may comprise an attachment, wherein the attachment is configured such that the structural panel can be attached to a lifting arrangement and lifted by the lifting arrangement, the attachment being an attachment close to or at a locking member and comprising at least one of:
a recess into the locking member, the recess being configured to receive a hook for lifting the structural panel by the hook in the recess;
a hole into the locking member, the hole being configured to receive a bolt for lifting the structural panel by the bolt in the hole;
a hole through a part of the locking member, the hole being configured to receive a strap laced through the hole for lifting the structural panel by the strap laced through the hole.

The hole may also receive a hook. The hook may be a clamping device comprising one or several hooks that may be pressed into the load bearing laminate of layers. The attachments may extend from the surface of the panel.

Thus, the structural panel comprising an attachment may be lifted by the lifting arrangement rather than lifted by hand. This may be advantageous as structural panels may be large and heavy. By placing the attachment close to or at a locking member, precise control of the rotational movement may be achieved. Thus, interlocking the first and second locking members may be achieved rapidly even if the structural panel is handled by a crane or similar lifting device.

As an example, consider a structural panel being lifted by a lifting arrangement, the lifted structural panel having one locking member at one edge and another locking member at an opposite edge. The lifted structural panel is being connected to another, already installed, structural panel.

Advantages may be achieved by providing an attachment close to or at the locking member at the edge that is being connected. During the assembly process an attachment to the lifted structural panel, close to or at the locking member at the edge that is being connected, may allow the locking member to be precisely guided into the correct position, e.g. precisely guided by a crane operator or by a second guiding person, before starting the rotational movement. It may be easy for the crane operator or guiding person if the attachment to the lifting arrangement is close to the edge that is being connected. For example, an attachment to a second locking member comprising a tongue may enable guiding said tongue into a tongue groove.

Advantages may alternatively, or additionally, be achieved by an attachment to the locking member close to or at the edge opposite to the edge that is being connected. Since the opposing edge may be far from the edge being connected, a relatively large shift of the opposing edge may result in a relatively small angular movement. Thus, the rotational movement may be precisely controlled with an attachment to the locking member close to or at the edge opposite to the edge that is being connected.

Further, during manufacturing of the structural panel it may be efficient to manufacture the attachment at the same place as the locking member. For example, manufacturing the locking member may be done by milling the load bearing laminate of layers. Milling the attachment, or part of the attachment, simultaneously may then be efficient.

In the case where the attachment is a recess into the locking member, the recess may be configured to be obscured from sight by the first and second structural panels when the mechanical locking system is in the locked disposition.

A structural panel may comprise four attachments. It may be three. Attachments may be arranged close to the corners of the structural panel. It may arranged close to the middle of an edge. A combination of the attachment types may be used, e.g. two holes at the panel top surface close to or in the tongue at second locking member and two holes at the top surface close to the second locking member or in the tongue groove of said locking member.

The set of structural panels may be configured such that, in the locked disposition, the load bearing laminate of layers of the first structural panel and the load bearing laminate of layers of the second structural panel align to form one common laminate of layers wherein each layer of the common laminate of layers extends in both the first and second structural panel, the common laminate of layers comprising at least one C-layer, the C-layer being a wooden layer with wood fiber direction orthogonal to the edges of the interlocked first and second locking members, wherein
at least one of the at least one C-layer is part of the upper lip of the first locking member but not part of the tongue of the second locking member; and/or
at least one of the at least one C-layers is part of the lower lip of the first locking member but not part of the tongue of the second locking member, and/or
at least one of the at least one C-layers is part of the tongue of the second locking member but not part of the upper or lower lips of the first locking member.

For example, the first and second structural panel may be made of CLT. Each layer of the CLT may comprise solid wood members, such as lumber boards arranged side by side in parallel. All solid wood members within a layer may have the same wood fiber direction. The wood fiber direction of neighboring layers of the CLT may be orthogonal to each other. The solid wood members of neighboring layers of the CLT may be orthogonal to each other. Every second layer of the CLT of the structural panel may be a C-layer, wherein the wood fiber direction of the solid wood members is orthogonal to the edge of the first or second locking member of the structural panel. The remaining layers may be A-layers, wherein the wood fiber direction of the solid wood members is aligned with the edge of the first or second locking member of the structural panel. The order and thickness of the CLT layers of the first and second structural panels may be the same, such that when the first and second structural panels are interlocked the CLT layers of the first and second structural panels align to form one common laminate of layers. It is not excluded that two neighboring layers may have aligned fibers. It may be two A-layers or C-layers that are aligned.

When a part of the mechanical locking system, such as the upper lip; the tongue; or the lower lip, comprise a C-layer of its own, the strength of said part may be high. The mechanical locking system may e.g. be resilient against bending forces. As the wood fibers of a C-layer extend in a direction orthogonal to the edge of the locking member the layer may continue unbroken with overlapping wood fibers far into the structural panel, in many cases to the opposite edge of the structural panel. This may be advantageous as discontinuities in the wood may correspond to weak points. For example, a bundle of fibers bent in the fiber direction may resist larger forces than a bundle of fibers bent perpendicular to the fiber direction. The least favorable may be a discontinuous A-layer, where bending across the fibers may constitute a weak load bearing layer. If in addition the lumber boards in the layers are not glued together, then this may constitute a fiber discontinuity and as such have greatly reduced load bearing capacity. The strength of the mechanical locking system may be particularly high when the tongue comprises a C-layer of its own, i.e. a C-layer of the common laminate of layers that is part of the tongue but not part of the upper or lower lip. The C-layer should preferably extend at least partially past the locking groove. Even more preferable that the C-layer in the tongue pass the locking groove with maintained thickness. A lip comprising an A-layer shall preferably comprise a C-layer, preferably on all lips of the first and second locking member.

The strength of the mechanical locking system may be particularly high when the upper lip comprises a C-layer of its own; and the tongue comprises a C-layer of its own; and the lower lip upper lip comprises a C-layer of its own.

It should be noted that for a floor panel the top and bottom layer is advantageously an A-layer aligned with the longest edges.

In case the first and second structural panel have different thickness, consequently most likely comprise layers of different position and thickness in relation to each other, it may then be desirable to align either the bottom or the top surface of the two panels, while positioning the locking members. It is in this case advantageous if the above mentioned preferred configuration of the C-layers in the lips and tongue of both panels are fulfilled.

However, it should be understood that layers which are not C-layers may also have advantages. For example, at least one lip of the first locking member may comprise at least two parallel solid wood members, within the same layer of the load bearing laminate of layers of the first structural panel, each solid wood member having a wood fiber direction parallel to the edge at which the first locking member is arranged. To illustrate the above, the first structural panel may be a CLT panel, wherein the upper and/or lower lip of the first locking member of the first structural panel comprises an A-layer. Said A-layer may comprise two solid wood members, such as two lumber boards, parallel to each other and parallel to the edge of the first locking member.

Although most of the A and C layer combinations above are described on the lips of the first locking member, it should be understood that the description applies on the second locking member too, when regarding the lip in this context as the part comprising the portion of the locking member from the uppermost portion of the locking groove to the outermost part of the uppermost part of the tip of the tongue. At least part of a C-layer of such lip portion of the second locking member may align with at least part of a C-layer of the upper or lower lip of the first locking member.

The use of at least two parallel solid wood members in a lip may be advantageous as the interface between the two parallel solid wood members may form a dilation joint. The interface between the two parallel solid wood members may either comprise adhesive or be free from adhesive.

It should be understood that a lip with at least two parallel solid wood members may have advantages also for structural panels with a non-rotational mechanical locking system. For example, a CLT structural panel, e.g. a CLT floor or wall structural panel, with a non-rotational mechanical locking system may advantageously have a lip with at least two parallel solid wood members (with or without adhesive). It may be a tongue and groove connection system.

The set of structural panels may be configured such that, in the locked disposition, the load bearing laminate of layers of the first structural panel and the load bearing laminate of layers of the second structural panel align to form one common laminate of layers wherein each layer of the common laminate of layers extends in both the first and second structural panel,
wherein, in the locked disposition,
   a surface of the tongue of the second locking member and a surface of the lower lip of the first locking member both lie in a plane defined by an interface between two layers of the common laminate of layers, and/or
   a surface of the tongue of the second locking member and a surface of the upper lip of the first locking member both lie in a plane defined by an interface between two layers of the common laminate of layers.

The surfaces may be contact surfaces between the locking members. They may prevent displacement orthogonal to the plane of the installed panels. In many examples referred to as vertical locking.

When surfaces of a tongue and/or a lip lie in a plane defined by an interface between two layers of the common laminate of layers little material may need to be removed during shaping of the locking members. This may make the manufacturing faster, more efficient, and/or cheaper. Further, not removing much material may be environmentally friendly as resources are saved. The above mentioned advantages may be particularly easy to achieve when the method for constructing a structural panel according to the second aspect is used. Both vertical locking surfaces may off course also comprise portions that are, or that are entirely, positioned spaced from the interface surfaces between layers providing a gap or play. It may be preferable due to tolerances of the laminate layers to use only one of the two vertical locking surface in an interface plane whereas at least one of the other locking surfaces is positioned spaced from the interface plane, e.g. in a A or C-layer or in an added material. If only one interference layer is chosen, it may then be preferable to use the interference surface that is closest of the two vertical locking surfaces to its closest surface of the panel.

The tongue of the second locking member may comprise:
an upper locking surface configured to, when in contact with the upper lip of the first locking member, prevent separating movements of the first and second structural panels in at least one direction orthogonal to the aligned planes of the first and second structural panels; and
a lower locking surface configured to, when in contact with the lower lip of the first locking member, prevent separating movements of the first and second structural panels in at least one direction orthogonal to the aligned planes of the first and second structural panels,
   wherein the upper and lower locking surfaces are, at least partially, offset with respect to each other in a direction within the aligned planes of the first and second structural panels.

As an example of the above, consider the first and second structural panels being structural panels which are mounted horizontally, e.g. to form a floor. In this example the upper and lower locking surfaces of the tongue may be vertical locking surfaces which prevent separating movements of the first and second structural panels in a vertical direction. The upper and lower locking surfaces may, according to the above be partially offset with respect to each other in a horizontal direction, when mounted.

The upper locking surface may extend between an upper outer contact point and an upper inner contact point. The upper outer contact point is the contact point between the first and second locking member on the upper locking surface that is closest to the first structural panel. The upper inner contact point is the contact point between the first and second locking member on the upper locking surface that is closest to the second structural panel. Similarly, the lower locking surface may comprise a lower outer contact point, being the contact point between the first and second locking member on the lower locking surface that is closest to the first structural panel. Further, the upper lip may have a contact plane, wherein the contact plane is orthogonal to the plane of the first structural panel and comprises an outermost contact point of the upper lip to the second locking member.

As described below, the mechanical locking system may be configured such that a lower outer contact point is closer to the center of the second structural panel than the upper inner contact point and the upper lip contact plane are. The mechanical locking system may be configured such that the lower outer contact point is closer to the center of the second structural panel than the upper outer contact point but further away from the center of the second structural panel than the upper inner contact point.

Having the upper and lower locking surfaces offset with respect to each other may be advantageous as it may facilitate the rotational movement. For example, the lower locking surface of the tongue of the second locking member may be further away from the center of the first structural panel than the upper locking surface of the tongue of the second locking member. This may facilitate the second structural panel coming in towards the first structural panel from above, at an angle, and then being rotated by the rotational movement until the lower locking surface of the tongue hits the lower lip of the first locking member and stops the rotational movement with the planes of the first and second structural panels aligned. It may allow a vertical press fit, comprising the tongue being thicker than the tongue groove, with maintained ease of installation. It may be thicker in the vertical direction than the tongue groove of the first locking member. In an embodiment where the lower contact point is beyond the upper lip contact plane or even more close to the upper outer contact point, then this may allow the horizontal locking to be horizontally tight, i.e. that the tongue is larger than the groove between the horizontal locking surfaces, while allowing the tongue of the second locking member to be equal or even to be thinner than the vertical distance between the planes in which the contact surfaces of upper and the lower lip of the first locking member align. An additional contact surface between the first and second locking member for vertical load is then advantageous, e.g. on the upper side of the locking element of the first locking member and an abutting surface in the locking groove of the second locking member. They may be aligned with the plane. The horizontal locking surfaces may comprise the contact surface of the upper lip in the contact plane of the first locking member and the abutting surface on the second locking member in interconnected state and it may comprise the contact surface on the locking element (described below) of the first locking member and the abutting surface on the second locking member in interconnected state. A vertical locking surface on the locking element and locking groove may be combined with press fit or play or gap in the vertical and/or the horizontal locking.

The locking element of the first locking member and the locking groove of the second locking member may each comprise a locking surface, wherein the locking surfaces of the first locking member and of the second locking member are surfaces configured to, when in contact with each other, prevent a separating movement of the first and second structural panels in a direction within the aligned planes of the first and second structural panels and orthogonal to the edge directions of the edges of the first and second structural panels at which the respective first and second locking members are arranged;
wherein the first locking member and the second locking member each comprises a contact axis, the contact axis being an axis along which the first and second locking members may be in contact during the rotational movement and around which the rotational movement takes place;
wherein the first locking member has a minimum rotational radius, being a smallest distance between the contact axis of the first locking member and the locking surface of the locking element of the first locking member, measured in a direction orthogonal to the contact axis of the first locking member;
wherein the second locking member has a maximum rotational radius, being a largest distance between the contact axis of the second locking member and the locking surface of the locking groove of the second locking member, measured in a direction orthogonal to the contact axis of the second locking member;
wherein the first and second locking members are configured such that:
in the locked disposition, parts of said locking surface of the second locking member which have the maximum rotational radius of the second locking member are closer to a lower side of the interlocked structural panels than parts of said locking surface of the first locking member which have the minimum rotational radius of the first locking member, the lower side of the interlocked structural panels being a side comprising the lower lip; and
the minimum rotational radius of the first locking member is equal to or larger than the maximum rotational radius of the second locking member, whereby a rotational play, being a play between the first and second locking members during the rotational movement is equal to or larger than 0 mm.

The contact axis may be positioned at the uppermost edges of the first and the second locking members.

It is a further realization that for a structural panel, a rotational play that is equal to or larger than 0 mm may be advantageous. A structural panel may be very heavy which may lead to large forces that may damage the locking surfaces if the rotational play is negative. Further, a structural panel may need to be installed using a crane, or similar, which may be hard to control very precisely. In this situation a rotational play that is equal to or larger than 0 mm may be advantageous as it may allow installation with more coarse movements.

The above description relates to an over-angled mechanical locking system, wherein the first and second locking members are configured such that:
in the locked disposition, parts of said locking surface of the second locking member which have the maximum rotational radius of the second locking member are closer to the lower side of the interlocked structural panels than parts of said locking surface of the first locking member which have the minimum rotational radius of the first locking member.

It should be understood that, as an alternative, the mechanical locking system may be under-angled, wherein the first and second locking members are configured such that:
in the locked disposition, parts of said locking surface of the second locking member which have the maximum rotational radius of the second locking member are further away from the lower side of the interlocked structural panels than parts of said locking surface of the first locking member which have the minimum rotational radius of the first locking member.

In the above, the contact axis of the first locking member is considered to run along the edge of the first structural panel, within the plane of the upper surface of the first structural panel. Similarly, the contact axis of the second locking member is considered to run along the edge of the second structural panel, within the plane of the upper surface of the second structural panel. It should be understood that, in a real-life situation, the actual contact axes of the locking members may move slightly during the rotational movement. However, in most cases from a practical and consequently engineering perspective, the contact axis may be approximated as a static axis according to the above.

A different way of describing the above is that the first locking member and the second locking member comprises a common contact axis. The minimum rotational radius of the first locking member may then be defined as a smallest distance between the common contact axis and the locking surface of the locking element of the first locking member, measured in a direction orthogonal to the common contact axis. The maximum rotational radius of the second locking member may then be defined as a largest distance between the common contact axis and the locking surface of the locking groove of the second locking member, measured in a direction orthogonal to the common contact axis. In analogy to the above, said common contact axis may move slightly during the rotational movement. However, the relation, that the minimum rotational radius of the first locking member is equal to or larger than the maximum rotational radius of the second locking member, may still hold even if the common contact axis moves.

In the case of an over-angled mechanical locking system, the first and second locking members may as an exception be configured such that the minimum rotational radius of the first locking member may be smaller than the maximum rotational radius of the second locking member if the milling process is extremely precise, the fiber orientation and wood density is advantageous and the board is unusually dimensionally stable. An advantageous fiber direction may be a locking element comprising a C-layer. Another preferred embodiment, in an under-angled mechanical locking system, is that the minimum rotational radius of the second locking member is equal or larger than the minimum rotational radius of the first locking member but smaller than the maximum rotational radius of the first locking member. It can also be larger than the maximum rotational radius of the first locking member. Both embodiments result on horizontal press fit. The tongue may in this case be horizontally larger than the tongue groove. This facilitates a wide initial gap in the angled position between the surfaces for more coarse movements by the crane, and when horizontally engaged it may give a tight or even press fit in the horizontal locking direction. The horizontal locking direction may be a direction within the aligned planes of the first and second structural panels and orthogonal to the edge directions of the edges of the first and second structural panels at which the respective first and second locking members are arranged.

A contact surface of the locking element may be configured with a maximum rotational radius between a minimum rotational radius on the locking surface that is closest to the lower lip and an equally sized minimum rotational radius that furthest away from the lower lip. The contact surface may alternatively be curved shaped with a common rotational radius along the locking surface. Alternatively, the locking surfaces may be straight. Alternatively or additionally, the locking surfaces may be complementary in shape.

It should be understood that in some embodiments the minimum rotational radius of the first locking member may be equal or smaller than the maximum rotational radius of the second locking member.

The first and second locking members may be configured such that a difference between the minimum rotational radius of the first locking member and the maximum rotational radius of the second locking member is between 0 and 5 mm. This may correspond to a rotational play between 0 and 5 mm which may be advantageous as it may allow the structural panels being installed by a crane or similar without the structural panels being too loosely connected once the mechanical locking system is in the locked disposition.

As an addition or alternative to the rotational play, the set of structural panels may be configured may be configured to have a play in the locked disposition. The set of structural panels may be configured such that a play in the locked disposition is at least 0 mm, such as e.g. between 0 and 5 mm, wherein the play in the locked disposition is a distance that the first and second structural panels can move relative to each other in a direction within the aligned planes of the first and second structural panels and orthogonal to the edge directions of the edges of the first and second structural panels when the mechanical locking member is in the locked disposition.

It should be understood that the play in the locked disposition referred to is the play at any point along the interlocked first and second locking member. For example, if the first and second structural panels are interlocked, with the mechanical locking system in the locked disposition, a segment may be cut orthogonal to the interlocked edges. The segment may be, say, 50 mm wide and comprise both the first and second locking member at that point along the edges of the same panel. If the first and second locking member of the segment can move a distance x mm relative to each other, then the play in the locked disposition at that point along the edges is x mm. The distance is measured as the orthogonal movement from when the segments are pressed against each other and to the position when pulled away from each other with a force being not greater than 25%, preferably not more than 10%, of the maximum locking strength which is defined as when the segments separate by fracture or by the locking element sliding out of the locking groove when pulled apart in the horizontal direction, e.g. in the direction within the aligned planes of the first and second structural panels and orthogonal to the edge directions of the edges of the first and second structural panels.

Several of the embodiments above disclose a novel general locking system design. The locking system comprising a first locking member in a first panel and a second locking member in a second panel comprise a dual locking geometry design. This is beneficial also for indoor floor coverings like parquet and laminate flooring. The locking members of the locking system along abutting connected edges may comprise a first locking system geometry in first cross cut view of the abutting panels and a second or several different geometries in other cross cut views along the contact axis. One example as disclosed above is a system with a locking element connected to the locking groove in the first locking member in one cross section view and a second locking element connected to the locking groove in the second locking member. As an additional example, the locking element of the first or second locking member may comprise a first lower locking element in a first cross cut view and a second higher locking element in a second cross cut view. A further example is a system with a loose vertical fit in a first cross cut view and a neutral or press fit vertically in a second cross cut view. The loose vertical fit section may be positioned where a third structural panel or beam is intended to abut orthogonally to the connected panels.

According to a second aspect, there is provided a method for constructing a structural panel, the method comprising:
stacking a set of layers, the set of layers being stacked in a direction from a lower side to an upper side;
arranging the layers of the stacked set of layers such that a first subset of layers protrudes beyond at least part of remaining layers of the stacked set of layers at a first edge of the stacked set of layers, whereby a central part of the stacked set of layers comprises all layers of the stacked set of layers and a first protruding part of the stacked set of layers comprises the first subset of layers;
providing adhesive between each layer of the stacked a set of layers;
pressing an uppermost layer of the central part of the stacked set of layers and a lowermost layer of the central part of the stacked set of layers towards each other, to bond the layers of the central part of the stacked set of layers together;
pressing an uppermost layer of the first protruding part of the stacked set of layers and a lowermost layer of the first protruding part of the stacked set of layers towards each other, to bond the layers of the first protruding part of the stacked set of layers together;
shaping the first protruding part of the stacked set of layers to form a locking member of the first protruding part, the locking member of the first protruding part being configured to interlock the structural panel with another structural panel.

To illustrate the above: the set of layers may be stacked, with adhesive between each layer, on a first press member. Two or more layers at the top may be offset from the lower layers and thereby form the first subset of layers protruding beyond the remaining layers. A second press member may be placed on the uppermost layer of the stacked set of layers. If the first and second press member are flat and are pressed towards each other, an uppermost layer of the central part of the stacked set of layers and a lowermost layer of the central part of the stacked set of layers may be pressed towards each other and bonded together. However, in this situation the first subset of layers within the first protruding part may not be pressed together as there may be no press member in contact with the lower side of the first protruding part. A third press member can be placed at the lower side of the first protruding part such that the second and third press member may press an uppermost layer of the first protruding part of the stacked set of layers and a lowermost layer of the first protruding part of the stacked set of layers towards each other and bond the layers of the first protruding part together. This may ensure a strong first protruding part which in turn may make the locking member shaped out of the first protruding part stronger.

The method for constructing a structural panel provides environmentally friendly and cost-effective structural panels as illustrated by the following example. Instead of first forming the first protruding part and then pressing the layers of the first protruding part together it would be possible to arrange the layers of the stacked set of layers without a protruding part and bond them together by pressing the top and bottom layer towards each other. A protruding part, such as a locking member, could then be shaped out of the entire stacked set of layers. However, this would possibly require a large amount of material being removed and discarded which would take time and waste material and energy. Thus, the method according to the second aspect provides fast, efficient, cheap and/or environmentally friendly manufacturing of structural panels.

It should be understood that the above given example with three press members is an example. The method may be implemented in various other ways, e.g. using a vacuum press and/or using a filling block as described below.

The locking member shaped out of the first protruding part may be part of the first or second locking member described above.

The set of layers may be configured to form a load bearing laminate of layers once the layers of the set of layers have been bonded together.

The method is herein described as a method for constructing a structural panel. It should be understood that the structural panel may be part of a rotational locking system or a non-rotational locking system.

However, it should be understood that the method may alternatively be used for constructing other panels than structural panels. For example, a click-lock laminate floor panel may be constructed, in which case the set of layers may not necessarily be configured to form a cross laminated load bearing laminate of layers once the layers of the set of layers have been bonded together.

The method for constructing a structural panel may further comprise:
forming a locking member, configured to interlock the structural panel with another structural panel, at an edge of the stacked set of layers which is different from the first edge. The edge different from the first edge may be a second edge of the stacked set of layers, wherein the second edge of the stacked set of layers is opposite to the first edge of the stacked set of layers.

As an example of the above, the method for constructing a structural panel may further comprise:
arranging the layers of the stacked set of layers such that a second subset of layers protrudes beyond at least part of remaining layers of the stacked set of layers at a second edge of the stacked set of layers, whereby a second protruding part of the stacked set of layers comprises the second subset of layers, wherein the second edge of the stacked set of layers is opposite to the first edge of the stacked set of layers;
pressing an uppermost layer of the second protruding part of the stacked set of layers and a lowermost layer of the second protruding part of the stacked set of layers towards each other, to bond the layers of the second protruding part of the stacked set of layers together;
shaping the second protruding part of the stacked set of layers to form a locking member of the second protruding part, the locking member of the second protruding part being configured to interlock the structural panel with another structural panel.

Thus, two locking members may be formed on the structural panel at opposing edges. One locking member may be the first locking member described above and the other locking member, at the opposite edge, may be the second locking member discussed above. Thus, a dual use structural panel may be formed. Both the first and second protruding part, at the opposite edges, may be strong as their respective layers have been pressed together during their respective bonding process. This may in turn make the locking members, shaped out of the first and second protruding part, strong.

Pressing an uppermost layer of the second protruding part of the stacked set of layers and a lowermost layer of the second protruding part of the stacked set of layers towards each other may be done using a fourth press member, e.g. using a fourth press member and a first press member, as described in conjunction with FIG. 20.

The first subset of layers and the second subset of layers may both comprise at least one common layer of the stacked set of layers. Thus, one layer may extend from the first protruding part, trough the central part of the stacked set of layers into the second protruding part. This may be advantageous if e.g. a first locking member is shaped out of the first protruding part and a second locking member is shaped out of the second protruding part. The first locking member may then be shaped such that it may interlock with a second locking member (of a different, identical, panel) and vice versa. Having one common layer in the first and second protruding part may enable shaping of interlocking parts of the first and second locking member.

For example, the common layer of the first and second protruding part may be shaped by milling. During said milling, material may be removed from the common layer of the second protruding part to form a locking groove. At a corresponding position of the first protruding part, material in the common layer of the first protruding part may be saved during the milling, to form a locking element. Thus, a locking groove and a locking element, configured to interlock, may be formed out of the common layer.

At least one layer in the first subset of layers and at least one layer in the second subset of layers may have a common width, the common width being a width in a direction orthogonal to the first and second edges. Thus, the width may be a distance from the first to the second edge. Using layers of a common width facilitates an effective manufacturing process. It may be cheap and resource saving to use layers of the same width (it may be cheap and resource saving to only use layers of the same width). This may be especially true for C-layers of a CLT structural panel. A C-layer of a CLT structural panel may comprise solid wood members, such as continuous finger jointed lumber boards, extending from the first edge to the second edge. Keeping only one length, or only a few lengths, of lumber boards in stock rather than keeping many different lengths in stock may save cost. Further, when a lumber board do not need to be cut to a certain length depending on which subset of layers it is going to be placed in, time may be saved and less material may be wasted. For A-layers the width may be less important. An A-layer of a CLT structural panel may comprise solid wood members, such as lumber boards, placed parallel to the first and second edge. Said lumber boards may be placed side by side from the first edge to the second edge. Thus, the width of an A-layer may be adjusted by merely placing fewer or more lumber boards. It may therefore be advantageous if a common layer that belongs both to the first and second subset of layers, and therefore may be wider than other layers, is an A-layer.

The method for constructing a structural panel may further comprise
bonding, to the first or second protruding part of the stacked set of layers, a sacrificial segment, being a segment that is at least partially removed during the shaping of the first or second protruding part. The sacrificial segment may be a segment comprising wood. The sacrificial segment may be smaller than a full layer of the stacked set of layers. The sacrificial segment may be thinner than a layer of the stacked set of layers, e.g. a 2 mm spruce or pine wood veneer strip preferably with fiber orientation aligned with the edge. Thus, material may be saved when using a sacrificial segment. Shaping a part of a locking member out of a sacrificial segment may result in less waste than if said part had to be shaped out of a layer of the stacked set of layers.

The method for constructing a structural panel may further comprise
bonding, to the first or second protruding part of the stacked set of layers, either
   a reinforcement segment, being a segment having greater hardness, and/or greater ductility, than the majority of layers comprised in the stacked set of layers, wherein the reinforcement segment form at least part of the locking member of the first or second protruding part; or
   a replacement segment, being a segment replacing part of a layer of the first or second protruding part of the stacked set of layers, wherein the bonding of the reinforcement segment or the replacement segment is done before or after forming and shaping the protruding part.

The reinforcement segment may be a part of a locking member which is particularly vulnerable to deformation or failure when the connected first and second structural panels bear a structural load. For example, the first protruding part may be shaped into a lower lip of the first locking member after which a reinforcement segment in the form of a locking element is bonded to said lower lip. The locking element may be continuous or discontinuous with space in between each element in order to save material. In another example a reinforcement segment is bonded to the first protruding part after which the first protruding part and the reinforcement segment are shaped to form the lower lip and locking element of the first locking member. The two examples with separately bonded locking elements can be used to bond a locking element protrusion also on the second locking member in using the same methods of shaping. The reinforcement segment may be made of wood, e.g. a harder and/or more ductile type of wood than the majority of layers comprised in the stacked set of layers, e.g. a harder and/or more ductile type of wood than all the layers comprised in the stacked set of layers. The reinforcement segment may alternatively be made of other materials, e.g. metal or plastic. The reinforcement segment may comprise a laminate of layers. The reinforcement segment may comprise plywood.

A replacement segment may also strengthen the locking member even if the replacement segment does not necessarily need to be harder or more ductile than the majority of layers comprised in the stacked set of layers. Adhesive used for bonding the replacement segment may strengthen the locking member. As the replacement segment replaces part of a layer of the first or second protruding part the bond between the replacement segment and the first or second protruding part may lie in a different plane than other bonds between the layers of the stacked set of layers, this may strengthen the locking member. The replacement segment may be made of wood and replace wood in the first or second protruding part. The wooden replacement segment and the replaced wood may have different wood fiber directions.

This may strengthen the locking member. The replacement segment can use the same bonding and shaping methods, e.g. continuous or discontinuous locking element segment shaped before or after bonding, as described under the reinforcement segment chapter above.

It should be understood that the concept of sacrificial segments, reinforcement segments and replacement segments may have applications in other panels than structural panels. Similar or other advantages may be achieved e.g. for click-lock laminate floor panels.

It should be understood that the concept of sacrificial segments, reinforcement segments and replacement segments may have advantages both for constructing structural panels part of a rotational locking system and structural panels part of a non-rotational locking system.

It should be understood that the concept of sacrificial segments, reinforcement segments and replacement segments may have advantages also for non-structural panels with a rotational mechanical locking system. For example, a click-lock laminate floor panel may advantageously be constructed using such segments. The applicant reserves the right to file divisional applications relating to said segments in these contexts.

The stacked set of layers may comprise at least a first and a second wooden layer, the first wooden layer having a wood fiber direction orthogonal to a wood fiber direction of the second wooden layer. Layers with orthogonal wood fiber directions may provide a strong structural panel. One of the first and second wooden layer may have a wood fiber direction parallel to the first or second edge. The first wooden layer may comprise solid wood members, such as lumber boards, arranged side by side in parallel. The second wooden layer may comprise solid wood members, such as lumber boards, arranged side by side in parallel. All solid wood members within a layer may have the same wood fiber direction. Thus, after bonding the first and second wooden layer may form CLT layers. The wood fiber direction of neighboring layers of the stacked set of layers may be orthogonal to each other.

The method for constructing a structural panel may further comprise
setting a zero point for a milling machine, wherein the zero point is either
   a point in a plane comprising an interface between the first subset of layers and the remaining layers of the stacked set of layers or,
   a point on an outer surface of the stacked set of layers, wherein the outer surface lies on the, upper or lower, side of the stacked set of layers that is closest to the interface between the first subset of layers and the remaining layers of the stacked set of layers; and
shaping the locking member of the first protruding part using the milling machine with the set zero point.

It is a realization that such a zero point may enable accurate shaping of the first protruding part. Such accurate shaping may enable manufacturing of structural panels that can be interlocked by a rotational movement. The accuracy of the milling may decrease with distance from the zero point. The zero point described above may be close to parts of the first locking member that needs to be accurately shaped for the rotational movement to work properly.

It should be understood that the concept of setting a zero point in the above described manner may have advantages both for constructing structural panels part of a rotational locking system and structural panels part of a non-rotational locking system.

It should be understood that the concept of setting a zero point in the above described manner may have advantages also for non-structural panels with a rotational mechanical locking system. For example, a click-lock laminate floor panel may advantageously be constructed by setting the zero point in the above described manner. The applicant reserves the right to file divisional applications relating to the setting of the zero point in this context.

The method for constructing a structural panel may further comprise
providing, before pressing the stacked set of layers together, a filling block at the protrusion at the first or second edge of the stacked set of layers, the filling block being a block shaped to fill a void between the protrusion and a plane of a surface of an outermost layer of the stacked set of layers,
wherein pressing the stacked set of layers together comprises pressing, by a press member, both the surface of the outermost layer of the stacked set of layers and the filling block, whereby the press member presses the outermost layer of the stacked set of layers directly and presses the protrusion via the filling block, wherein the filling block preferably is thicker than the void it fills. The filling block may preferably also be resilient.

A press, used for constructing structural panels, such as CLT structural panels, often comprises two flat press members. The solid wood members that are to form the CLT structural panel are stacked and placed on a bottom press member and a top press member presses from above.

The use of a filling block may facilitate the use of a conventional press to press an uppermost layer of the first protruding part of the stacked set of layers and a lowermost layer of the first protruding part of the stacked set of layers towards each other. The filling block may e.g. be placed between the flat bottom press member and the lowermost layer of the first protruding part of the stacked set of layers. Thus, the filling block may transfer the force from the bottom press member to the lowermost layer of the first protruding part of the stacked set of layers. Alternatively, the bottom and/or top press member may have a shape such that during pressing the bottom and top press members are in contact with the uppermost layer of the central part of the stacked set of layers and the lowermost layer of the central part of the stacked set of layers as well as with the uppermost layer of the first protruding part of the stacked set of layers and the lowermost layer of the first protruding part of the stacked set of layers.

It should be understood that the concept of a filling block in the above described manner may have advantages both for constructing structural panels part of a rotational locking system and structural panels part of a non-rotational locking system.

It should be understood that the concept of a filling block in the above described manner may have advantages also for non-structural panels with a rotational mechanical locking system. For example, a click-lock laminate floor panel may advantageously be constructed using a filling block in the above described manner. The applicant reserves the right to file divisional applications relating to the setting of the zero point in this context.

According to a third aspect, there is provided a method for assembling a structural member of a building out of a set of structural panels, wherein the set of structural panels comprises
a first structural panel and a second structural panel, each structural panel extending in a plane; and
a mechanical locking system, comprising:
   a first locking member arranged at an edge of the first structural panel and a second locking member arranged at an edge of the second structural panel,
wherein the mechanical locking system is configured to form:
   an unlocked disposition, wherein the first and second locking members of the mechanical locking system are in contact, with the plane of the second structural panel being at an angle to the plane of the first structural panel and the second structural panel being rotationally movable in relation to the first structural panel;
   a locked disposition, wherein the first and second locking members of the mechanical locking system are in contact, with the plane of the second structural panel being aligned to the plane of the first structural panel and the first and second locking members of the mechanical locking system being interlocked to prevent separating movements of the first and second structural panels in at least one direction orthogonal to the aligned planes of the first and second structural panels, and one direction within the aligned planes of the first and second structural panels,
      the method comprising:
installing the first structural panel in the building;
attaching a lifting arrangement to the second structural panel;
lifting the second structural panel by the lifting arrangement;
positioning the second structural panel, by the lifting arrangement, relative to the first structural panel in contact between the first and second locking members, with the plane of the second structural panel at an angle to the plane of the first structural panel and the second structural panel rotationally movable in relation to the first structural panel, whereby the first and second locking members form the mechanical locking system in the unlocked disposition;
   interlocking the first and second locking member, by moving the lifting arrangement to perform the rotational movement of the second structural panel in relation to the first structural panel, the rotational movement going from the unlocked disposition to the locked disposition.

It is a realization that even though structural panels generally are heavy and possibly cannot be lifted by hand, it is indeed possible to perform a rotational movement using a lifting arrangement. Further, a structural panel which cannot be lifted by hand may indeed be guided by hand while lifted by a lifting arrangement, whereby a controlled rotational movement may be achieved. The lifting arrangement may herein comprise one or more resilient elongated member such as a rope, wire or rod. The lifting arrangement may be attached in one end to a crane or similar lifting machine. The lifting arrangement may be attached in another end to the second structural panel, e.g. to an attachment of the second structural panel. A rope and/or rod may be part of a guiding arrangement and/or force transfer arrangement held by hand.

There may be different ways to position the second structural panel with the second locking member in contact with the first locking member and the plane of the second structural panel at an angle to the plane of the first structural panel.

For example, the second structural panel may be lifted at an angle to the first structural panel end moved to a position where the tongue enters the tongue groove and makes contact. The mechanical locking system may then be in the unlocked disposition and the rotational movement may start to move the mechanical locking system from the unlocked disposition to the locked disposition.

Alternatively, the second structural panel may be positioned with the second locking member in contact with the first locking member while the second structural panel is not angled to the first structural panel. When the lifting arrangement is completely released of tension, and if part of the lifting arrangement is connected to the second locking member of the second panel, this part may then be released from the panel. A reverse rotational movement of the second structural panel may then be performed, placing the second structural panel at an angle to the first structural panel. During the reverse rotational movement, the tongue of the second locking member may slip into the tongue groove of the first locking member and the mechanical locking system may be put in the unlocked disposition. The rotational movement, e.g. in an opposite direction to the reverse rotational movement, may then be performed to move the mechanical locking system from the unlocked disposition to the locked disposition.

When the second structural panel is lifted using the lifting arrangement it may be fully lifted and completely suspended by the lifting arrangement. Alternatively, the second structural panel may be at least partially lifted by the lifting arrangement. For example, the second locking member of the second structural panel may rest on the first locking member of the first structural panel while an edge of the second structural panel, opposite to the edge with the second locking member, is lifted by the lifting arrangement, whereby the second structural panel is partially lifted by the lifting arrangement. In said position the first and second locking members are in contact and the rotational movement may be performed such that they interlock. The rotational movement may e.g. be performed by moving the lifting arrangement towards the plane of the installed first structural panel. Thus, a rotational movement of the second structural panel may be performed by a straight movement of the lifting arrangement. When the first and second locking members are in contact, the second structural panel may pivot around a contact axis between the first and second locking members. Thus, a straight movement of the lifting arrangement may allow the second structural panel to rotate around the contact axis. For example, a lifting point of the lifting arrangement, e.g. a point where the lifting arrangement is lifted by e.g. a crane, may be moved towards the plane of the installed first structural panel. For example, if the first structural panel is lying in a horizontal plane and the second structural panel is hanging at an angle to the horizontal plane with the second locking member of the second structural panel resting on the first locking member of the first structural panel, the rotational movement may be performed by moving the lifting arrangement towards the horizontal plane. The contact between the first and second locking members may be maintained during the rotational movement. The second structural panel may thus pivot around the contact axis between the first and second locking members until the locked disposition is reached.

The method for assembling a structural member of a building may comprise
pressing the second structural panel against the first structural panel, while moving the lifting arrangement to perform the rotational movement of the second structural panel in relation to the first structural panel, wherein pressing the second structural panel against the first structural panel is performed either
   by the lifting arrangement, or
   by a force transfer arrangement attached to the second structural panel, the force transfer arrangement being separate from the lifting arrangement.

The second structural panel may be pressed against the first structural panel by pressing the second locking member against the first locking member, e.g. by pressing a tongue of the second locking member into a tongue groove of the first locking member. Pressing the second structural panel against the first structural panel may be performed before the rotational movement is performed, e.g. to move the tongue of the second locking member into a tongue groove of the first locking member. Additionally, or alternatively, pressing the second structural panel against the first structural panel may be performed during the rotational movement is performed, e.g. to ensure that the first and second locking members interlock properly, e.g. such that a locking element on a lower lip of the first locking member moves smoothly into a locking groove of the second locking member.

It should be understood that a force transfer member may have advantages also for assembling structural panels with a non-rotational mechanical locking system. For example, a CLT structural panel, e.g. a CLT floor or wall structural panel, with a non-rotational mechanical locking system may advantageously be assembled using a force transfer member.

The method for assembling a structural member of a building may comprise, when the first and second locking members are in contact,
shifting the second structural panel relative to the first structural panel.

Such a shift may complement the rotational movement and facilitate the first and second locking members interlocking smoothly.

For example, the second structural panel may be shifted towards the first structural panel. The second structural panel may be shifted towards the first structural panel such that a tongue of the second locking member enters, or moves further into, a tongue groove of the first locking member. Shifting the second structural panel relative to the first structural panel may be performed before the rotational movement. Alternatively, or additionally, the shift may be performed during the rotational movement, e.g. continuously during the rotational movement or occasionally during the rotational movement.

In another example, the edge of the second structural panel may be shifted along the edge of the first structural panel. For example, after the rotational movement the second structural panel may be shifted relative to the first structural panel along the aligned edges of the first and second structural panels.

In another example, the second structural panel may be shifted orthogonally towards the first structural panel to insert a protrusion, such as a tongue which is not the tongue of a rotational lock, into a groove in the second panel. The tongue and groove may further be provided with the third locking members, preferably obscured from sight, preventing shear movements relative the edge between the panels, the third locking members extending in an orthogonal direction to the edge, such as the orthogonal cavities, indentions, ridges and single sided truss plates, disclosed for the rotational locking between the first and second locking member which does not have the disclosed locking element and locking groove that will prevent the orthogonal shifting insertion. This example may be most advantageous in structural wall panels, where the short edges of the panels may be fixed to the structure by additional locking members, such as screw brackets, that will prevent separation of the panels away from each other. The tongue and groove may in one cross section view of the panels be configured as in the prior art FIG. 29A, 29B. In other cross section views the panels may be provided with the third locking members as disclosed in FIG. 7-9, 28. The protrusion in the groove may then prevent the first and second structural panels from moving in a direction orthogonal to the protrusion.

In another example, the second structural panel may be shifted orthogonally towards the first structural panel to allow a locking element enter a locking groove. In this case the mechanical locking system may lack a protrusion extending beyond the contact plane.

Shifting the second structural panel relative to the first structural panel may be performed by the lifting arrangement or by the force transfer arrangement.

The method for assembling a structural member of a building may comprise
providing a third locking member on the first or second locking member before interlocking the first and second locking member, wherein the third locking member is a locking member configured to, in the locked disposition of the mechanical locking system, resist a shear force, wherein the shear force is a force acting to separate the first and second structural panel in a direction parallel to the edges of the first and second structural panels at which the respective first and second locking members are arranged.

For example, a truss connector plate may be provided on the first or second locking member. As an example, a truss connector plate may be screwed to one of the first or second locking members before interlocking the first and second locking member. As another example, a truss connector plate may be placed in a cavity, such as an indentation, on the first locking member of the installed first structural panel. The truss connector plate may be placed such that metal teeth of the truss connector plate protrudes out of the cavity such that they may be inserted into the second locking member by the rotational movement. The truss connector plate may be placed such that the metal plate of the truss connector plate may slide in the cavity.

Alternatively, the truss connector plate may be a double sided truss connector plate. Such a double sided truss connector plate may have protruding metal teeth on both sides. When a double sided truss connector plate is placed on one of the first or second locking members, it may insert the protruding metal teeth on one side into the first locking member and the metal teeth on the other side into the second locking member, by the rotational movement of the second structural panel in relation to the first structural panel.

It should be understood that the third locking member may have advantages also for assembling structural panels with a non-rotational mechanical locking system. For example, a CLT structural panel, e.g. a CLT floor or wall structural panel, with a non-rotational mechanical locking system may advantageously be assembled using a third locking member.

It should be understood that the third locking member may have advantages also for assembling non-structural panels with a rotational mechanical locking system. For example, a click-lock laminate floor panel may advantageously be assembled using a third locking member. The applicant reserves the right to file divisional applications relating to the third locking member (and any feature of the third locking member) in these contexts.

The lifting arrangement may be configured to hold the plane of the second structural panel at an angle to a horizontal plane when the second structural panel is lifted by the lifting arrangement.

The angle may herein be an angle configured to place the mechanical locking system in the unlocked disposition when the first structural panel is lying horizontally and the second structural panel is positioned, by the lifting arrangement, with the second locking member in contact with the first locking member, with the plane of the second structural panel at the angle to the horizontal plane. The angle may be between 3 and 45 degrees to the horizontal plane, such as between 20 and 40 degrees.

It should be understood that the second aspect and/or the third aspect may have the same advantages, or similar advantages, as the first aspect encompassed by the claims in this application and may possibly be the subject of a future divisional application.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 illustrates a set of structural panels

FIG. 2 illustrates a set of structural panels in the unlocked disposition

FIG. 3 illustrates a set of structural panels in the locked disposition

FIG. 4 illustrates a set of structural panels

FIG. 5 illustrates a set of structural panels

FIG. 6 illustrates a set of structural panels

FIG. 7 illustrates a building panel, such as a structural panel, with third locking member

FIG. 8 illustrates a building panel, such as a structural panel, with third locking member

FIG. 9 illustrates truss connector plate and connector groove forming two-directional locking.

FIG. 10 illustrates a set of building panels, such as a set of structural panels, with connector plate combined with locking element forming three-directional locking.

FIG. 11 illustrates a set of building panels, such as a set of structural panels, with truss connector plate forming four-directional locking.

FIG. 12 illustrates a set of building panels, such as a set of structural panels, with truss connector plate

FIG. 13 illustrates a set of building panels, such as a set of structural panels, with a rotational play

FIG. 13B illustrates an under-angled mechanical locking system

FIG. 14 illustrates a structural panel with attachment

FIG. 15 illustrates a structural panel with attachment

FIG. 16 illustrates a structural panel with attachment

FIG. 17 illustrates a flow chart of a method for constructing a structural panel

FIG. 18 illustrates a stacked set of layers

FIG. 19 illustrates a stacked set of layers

FIG. 20 illustrates pressing a stacked set of layers

FIG. 21 illustrates pressing a stacked set of layers

FIG. 22 illustrates pressing a stacked set of layers

FIG. 23 illustrates a stacked set of layers with sacrificial segments

FIG. 24 illustrates a stacked set of layers with replacement/reinforcement segments

FIG. 25 illustrates a flow chart of a method for assembling a structural member of a building

FIG. 26 illustrates a time series of a structural member of a building being assembled out of a set of structural panels

FIG. 27 illustrates a time series of a structural member of a building being assembled out of a set of structural panels

FIG. 28 illustrates a time series of a structural member of a building being assembled out of a set of structural panels

FIG. 29 illustrates prior art structural panels.

FIG. 30 illustrates a set of building panels, such as a set of structural panels

FIG. 31 illustrates a set of structural panels

FIG. 32 illustrates a set of structural panels

FIG. 33 illustrates a guiding surface

FIG. 34 illustrates a guiding surface

### DETAILED DESCRIPTION

In cooperation with attached drawings, the technical contents and detailed description of the present invention are described thereinafter according to a preferable embodiment, being not used to limit the claimed scope. This invention may be embodied in many different forms and should not be construed as limited to the embodiments set forth herein; rather, these embodiments are provided for thoroughness and completeness, and fully convey the scope of the invention to the skilled person.

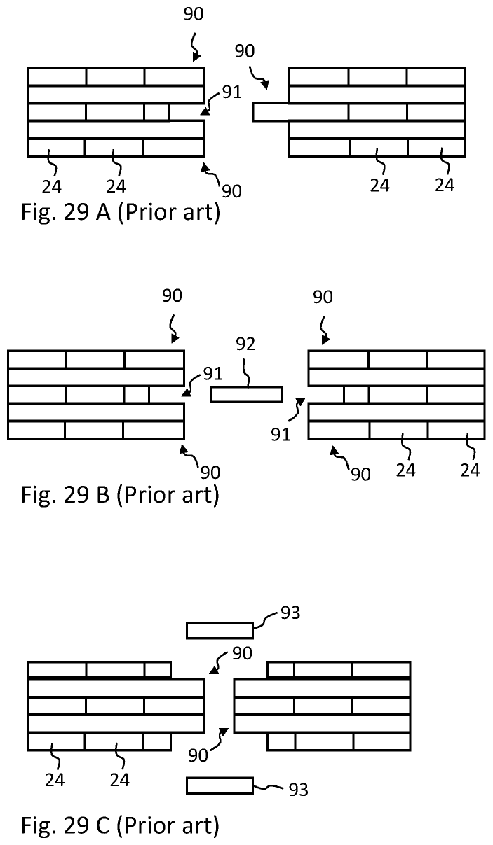

FIG. 29A-C illustrate cross-sections of prior art structural panels. The structural panels may be seen as structural panels part of a non-rotational mechanical locking system. The figures are schematic illustrations and it should be understood that the length and width of the structural panels may be substantially larger than the thickness of the structural panels. Each of the illustrated structural panels comprise a protrusion 90 at an edge.

FIG. 29A illustrates two structural panels, wherein the left panel comprises an edge with two protrusions 90 with a groove 91 between; and the right panel comprises an edge with one protrusion 90. The right panel may be connected to the left panel by inserting the protrusion 90 of the right panel into the groove 91 of the left panel. One or more screws may then be driven through both a protrusion 90 of the left panel and a protrusion 90 of the right panel.

FIG. 29 B illustrates two structural panels, wherein both the left and right panel comprises an edge with two protrusions 90 with a groove 91 between. The right and left panel may be connected by pushing them together with a loose tongue 92 going into both the grooves 91 of the left and right panel. One or more screws may then be driven through both a protrusion 90 and the loose tongue 92.

FIG. 29 C illustrates two structural panels, wherein both the left and right panel comprises an edge with a protrusion 90. The right and left panel may be connected by pushing them together such that the left and right protrusion abuts each other. One or more cover plates 93 may then be placed to bridge the abutting protrusions 90. One or more screws may then be driven through both a cover plate 93 and a protrusion 90.

The prior art structural panels illustrated may be CLT structural panels comprising solid wood members 24. The solid wood members 24 of neighboring layers of the CLT may be orthogonal to each other.

Protrusions 90 and grooves 91 according to the above may form part of locking members which do not interlock by a rotational movement.

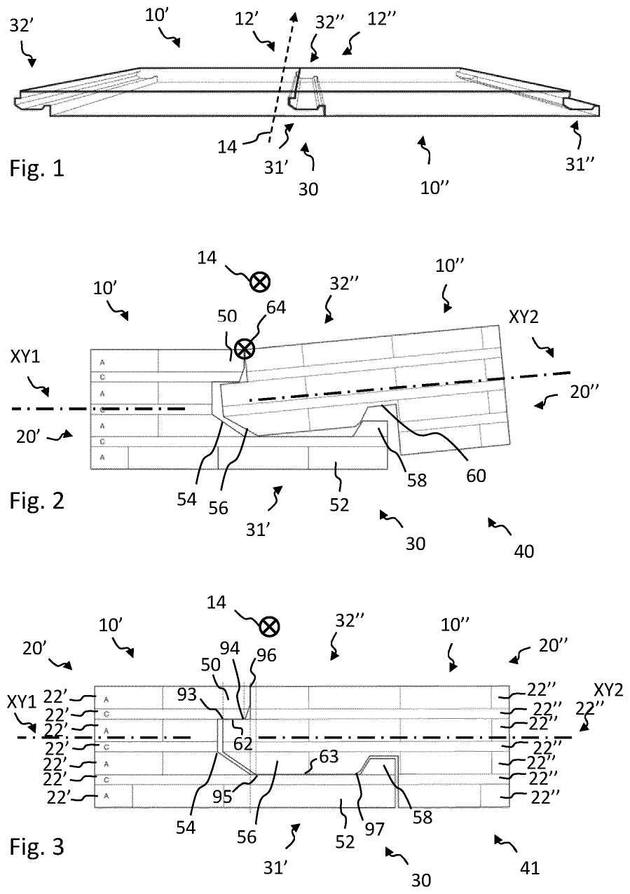

FIG. 1 illustrates a set of structural panels 10 according to the invention. The set of structural panels 10 comprising a first structural panel 10′ and a second structural panel 10″. The structural panels 10 are dual use structural panels and each comprise both a first 31 and a second 32 locking member. Thus, a dual use structural panel may be used either as a first structural panel 10′ or a second structural panel 10″. The first structural panel 10′ comprise a first locking member 31′ arranged at an edge 12′ of the first structural panel 10′, and a second locking member 32′ at an opposite edge. The second structural panel 10″ comprise a second locking member 32″ arranged at an edge 12″ of the second structural panel 10″, and a first locking member 31″ at an opposite edge. The first locking member 31′ of the first structural panel 10′ and the second locking member 32″ of the second structural panel 10″ together form a mechanical locking system 30 which, in the illustration, connects the first 10′ and second 10″ structural panels. Thus, the mechanical locking system 30 is in the locked disposition 41. In the figure the plane XY1 of the first structural panel 10′ and the plane XY2 of the second structural panel 10″ are aligned. Further, the edges 12′, 12″, that connect the first 10′ and second 10″ structural panels, also align. The illustrated structural panels 10 comprise a load bearing laminate of layers 20 which, in the interest of clarity, is not shown.

It should be understood that in the following, structural panels 10 will be illustrated with a focus on the mechanical locking system 30. The structural panels 10 may therefore be illustrated as relatively short. Structural panels 10 may have a width and length substantially larger than the thickness of the panel. A structural panel 10 may be rectangular. A structural panel 10 may have a length, measured along the edge 12, configured to correspond to a length or width of a room, or to the distance between the centre of two load bearing beams. The length of the structural panel 10 may e.g. be between 1.5 and 20 m. A structural panel 10 may have a width, measured in a direction orthogonal to the edge 12, configured to correspond to a fraction of a width or length of a room, e.g. a third or a fifth of a room. The width of the structural panel may e.g. be between 1.5 and 7 m.

FIG. 2 illustrates a first structural panel 10′ and a second structural panel 10″ respectively comprising a first locking member 31′ and a second locking member 32″, the first 31′ and second 32″ locking member form a mechanical locking system 30 which in the figure is in the unlocked disposition 40. FIG. 3 illustrates the same first 10′ and second 10″ structural panels, wherein the mechanical locking system 30 is in the locked disposition 41.

The first 10′ and second 10″ structural panels in FIG. 2-3 each comprise a load bearing laminate of layers 20′, 20″. Each layer of the load bearing laminate of layers 20′/20″ may be parallel to the plane XY1/XY2 in which the structural panel 10′/10″ extends.

The mechanical locking system 30 in FIG. 2-3 is configured in the following way:

The first locking member 31′ comprises an upper lip 50 and a lower lip 52, being respective protrusions of the load bearing laminate of layers 20′ of the first structural panel 10′ at the edge 12′ of the first structural panel 10′. The upper 50 and lower 52 lip both protrude in a direction orthogonal both to the normal of the plane XY1 of the first structural panel 10′ and to the edge direction 14 of the first structural panel 10′. The lower lip 52 is arranged below the upper lip 50. Between the upper 50 and lower 52 lip there is a tongue groove 54. Further, the upper lip 50 may have a contact plane 96, wherein the contact plane 96 is orthogonal to the plane of the first structural panel 10′ and comprise the outermost contact point of the upper lip 50 to the second locking member 32″.

The second locking member 32″ comprises a tongue 56, the tongue 56 being a protrusion of the load bearing laminate of layers 20″ of the second structural panel 10″ at the edge 12″ of the second structural panel 10″. The second locking member 32″ protrudes in a direction orthogonal both to the normal of the plane XY2 of the second structural panel 10″ and to the edge direction 14 of the second structural panel 10″.

The upper lip 50, lower lip 52, tongue groove 54, and tongue 56 may form a vertical lock of the mechanical locking system 30. Said parts may, in the locked disposition, prevent the first 10′ and second 10″ structural panel from moving relative to each other in both directions orthogonal to the aligned planes of the first 10′ and second 10″ structural panels. For example, if the structural panels 10 are installed horizontally (e.g. as structural floor panels in a building) the tongue 56 may be prevented from moving downwards by the lower lip 52 and prevented from moving upwards by the upper lip 50. Thus, vertical movements may be prevented. It should of course be understood that the structural panels 10 may not necessarily be installed horizontally, they may e.g. be installed vertically, e.g. as structural wall panels. In this case the upper lip 50, lower lip 52, tongue groove 54, and tongue 56 may prevent horizontal movements.

The mechanical locking system 30 in FIG. 2-3 is further configured in the following way:

The first locking member 31′ further comprises a locking element 58, the locking element 58 being a protrusion of the lower lip 52, in a direction normal to the plane XY1 of the first structural panel 10′. The locking element 58 may extend along the complete lateral side in the edge direction 14. The locking element 58 may extend partially, for instance having spaces along the side which are longer than the locking element. They can be close or at the ends of the lateral side, with at least one locking element section close to the middle of the side extension. The lengths of the locking element sections may be of different lengths and even different material, for instance a longer element in the middle relative the ends or the opposite. They may alternatively be of the same length. The same complete or partial extension may apply to the tongue protrusion 65 in the embodiment detailed in FIG. 32.

The locking element 58 and the tongue protrusion 65 may be integrated within the laminate of layers 20 or may be of separate material fixed to the lip/tongue or loosely positioned.

The second locking member 32″ further comprises a locking groove 60, the locking groove 60 being a recess into the load bearing laminate of layers 20 of the second structural panel 10″ at the lateral side of the second structural panel 10″, in a direction normal to the plane XY2 of the second structural panel 10″.

As illustrated in FIG. 2-3 the mechanical locking system 30 is configured such that the first 10′ and second 10″ structural panels may be connected by inserting the tongue 56 in the tongue groove 54 with the plane XY2 of the second structural panel 10″ at an angle to the plane XY1 of the first structural panel 10′ and performing a rotational movement. When the tongue 56 is inserted in the tongue groove 54 with the planes XY1/XY2 of the first 10′ and second 10″ structural panels angled, the mechanical locking system 30 may be in the unlocked disposition 40. In the unlocked disposition 40 the first 31 and second 32 locking members are in contact with each other and the edge directions 14 of the first 10′ and second 10″ structural panel may be aligned, as shown in FIG. 2.

From the unlocked disposition 40 a rotational movement may be performed to the locked disposition 41 where the planes XY1/XY2 of the first 10′ and second 10″ structural panels are aligned, as shown in FIG. 3. As illustrated in FIG. 2-3 the rotational movement may be performed around a contact axis 64 between the first 10′ and second 10″ structural panels. The contact axis 64 may be parallel to the aligned edge directions 14 of the first 10′ and second 10″ structural panels. The contact axis 64 may e.g. run through the uppermost and/or outermost point of the upper lip 50 of the first locking member 31′, as illustrated in FIG. 2. It should be understood that the contact axis 64 may move, e.g. move slightly, during the rotational movement. For instance the contact axis 64 may move vertically, e.g. along the contact plane. The second structural panel 10″ may pivot around the contact axis 64 during the rotational movement.

During the rotational movement the lower lip 52 may insert the locking element 58 into the locking groove 60. Thus, in the locked disposition 41, the locking element 58 and locking groove 60 may form a horizontal lock of the mechanical locking system 30. A separating movement in a direction within the aligned planes of the first 10′ and second 10″ structural panels, e.g. within the aligned planes and orthogonal to the edge direction 14, may thus be prevented by the locking element 58 and locking groove 60.

The above is an example of the general concept of a vertical lock based on a tongue and a tongue groove and a horizontal lock based on a locking element and a locking groove. In general terms it may be said that, the mechanical locking system 30 may be configured such that it in the locked disposition:
(i) prevent separating movements of the first 10′ and second 10″ structural panels in at least one direction orthogonal to the aligned planes of the first 10′ and second 10″ structural panels by a tongue 56 of the second locking member being inserted in a tongue groove 54 of the first locking member, the tongue 56 being a protrusion of the load bearing laminate of layers 20 of the second structural panel 10″ at the edge 12 of the second structural panel 10″, the tongue groove 54 being a recess into the load bearing laminate of layers 20 of the first structural panel 10′ at the edge 12 of the first structural panel 10′; and
(ii) prevent separating movements of the first 10′ and second 10″ structural panels in one direction within the aligned planes of the first 10′ and second 10″ structural panels by:
   a locking element 58 engaging a locking groove 60, wherein the locking element is a protrusion of the first locking member 31 and the locking groove 60 is a groove in the second locking member 32, or vice versa.

In such general terms, the locking element 58 may be considered to be any kind of protrusion of the first 31 or second 32 locking member, e.g. be integrally formed in the structural laminate of layers and/or comprise a separate material such as e.g. a truss connector plate or a block. Further, in such general terms, the locking groove 60 may be considered to be any kind of groove in the first 31 or second 32 locking member, e.g. a groove existing before the rotational movement takes place or a groove created by the rotational movement, e.g. created when a tooth of a truss connector plate is inserted in a locking member. The locking element 58 may be a protrusion of the first locking member 31 while the locking groove 60 is a groove in the second locking member 32. Alternatively, the locking element 58 may be a protrusion of the second locking member 32 while the locking groove 60 is a groove in the first locking member 31. Thus, a locking element 58 of one of the first 31 and second 32 locking members may be inserted in a locking groove 60 of the other of the of the first 31 and second 32 locking members.

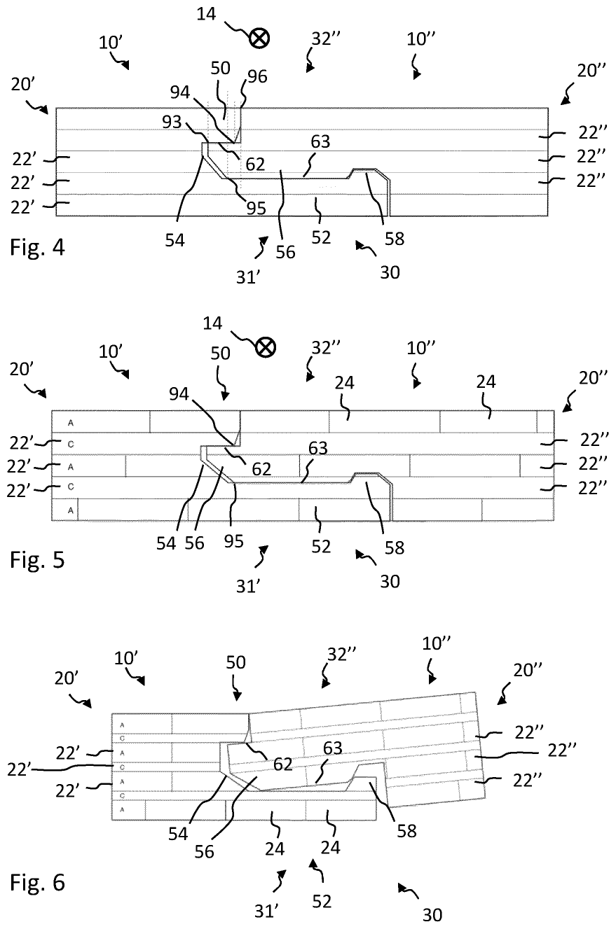

The first 10′ and second 10″ structural panels each comprise a load bearing laminate of layers 20′, 20″. This is illustrated in FIG. 2-3 and also in FIG. 4-6. The load bearing laminate of layers 20′/20″ comprise a number of layers 22′/22″. Some or all of the layers 22′/22″ may comprise wood. In said figures the load bearing laminate of layers 20′ of the first structural panel 10′ and the load bearing laminate of layers 20″ of the second structural panel 10″ align to form one common laminate of layers wherein each layer of the common laminate of layers extends in both the first 10′ and second 10″ structural panel (see FIG. 3-5).

The layers 22 of the load bearing laminate of layers 20 may be layers of chip board or oriented strand board, as illustrated in FIG. 4. Alternatively, or additionally, a layer 22 may comprise solid wood members 24. FIGS. 2, 3, 5 and 6 illustrates structural panels 10 wherein each layer 22 is made of solid wood members 24, such as lumber boards. The lumber boards may be finger jointed or by other means be continuous throughout the complete layer. The individual boards may be partially connected along their abutting sides by adhesive, e.g. maximum 20 percent of the thickness of the layer. They may even be spaced in the middle layers while preferably tightly abutted at the top and or the bottom. The spacing may be up to 30% of the lumber board width, even up to 150%. The spacing may be largest in the middle most layer. This layer set up is advantageous also when not providing the edges with rotational locking, e.g a straight edge, ship lap or an ordinary tongue and groove FIG. 29A. In FIGS. 2, 3, 5 and 6 the solid wood members 24 are arranged side by side in parallel for example. All solid wood members within a layer may have the same wood fiber direction and the wood fiber direction of neighboring layers are orthogonal to each other. FIG. 5 is used as an example. In FIG. 5 the uppermost layer 22 is an A-layer, wherein the wood fiber direction of the solid wood members 24 is aligned with the edge direction 14 of the interlocked first 31 and second 32 locking members (with aligned fibers is meant that a majority of the fibers are oriented completely aligned or at an angle of less than 45 degrees to the direction of the member direction to which the fibers align). Thus, lumber boards are arranged in parallel with each other and with the edge direction 14 in the A-layer. In FIG. 5 the second uppermost layer 22 is a C-layer, wherein the wood fiber direction of the solid wood members 24 is orthogonal to the edge direction 14 of the interlocked first 31′ and second 32′ locking members. In this context, orthogonal fiber direction may also encompass fiber directions which are at an angle of more than 45 degrees to the direction of the member direction to which the fibers are angled. Consequently OSB layers may be oriented orthogonal to each other and each layer may comprise one single board in one layer and several boards in the layer next to it. In FIG. 5 the load bearing laminate of layers 20 comprise alternating A- and C-layers preferably next to each other. The outermost layers are predominately of the same fiber direction; for structural flooring panels A-layer in advantageous in the cross cut view of the longest lateral edges; for wall panels the outermost layer may have a vertical orientation and may consequently also be an A-layer for vertically extending locking system and a C layer for horizontally extending locking system. The same applies to FIGS. 2, 3 and 6. Thus, FIGS. 2, 3, 5, and 6 may be seen as illustrating CLT structural panels.

FIGS. 3 and 6 illustrate a set of structural panels 10 wherein:
one C-layer is part of the upper lip 50 of the first locking member 31′ but not part of the tongue 56 of the second locking member 32″;
one C-layer is part of the lower lip 52 of the first locking member 31′ but not part of the tongue 56 of the second locking member 32;
one C-layer is part of the tongue 56 of the second locking member 32″ but not part of the upper 50 or lower 52 lips of the first locking member 31′.

FIG. 6 illustrates a lower lip 52 of a first locking member 31′ comprising two parallel solid wood members 24, within the same layer 22 of the load bearing laminate of layers 20 of the first structural panel 10′, each solid wood member 24 having a wood fiber direction parallel to the edge 12 at which the first locking member 31′ is arranged. Thus, FIG. 6 illustrates a lip wherein a C-layer of the lip comprises two full solid wood members 24. The lower lip, between the innermost point of the tongue groove 54, to the outermost point of the lower lip 52 comprises two full solid wood members 24. However, it should be understood that there may be advantages also if the C-layer comprise at least one full solid wood member 24 and one partial solid wood member 24. Such a configuration is shown e.g. in FIG. 5 wherein the lower lip 52 comprises one full solid wood member 24 and one partial solid wood member 24. When there is more than one solid wood member 24 in a lip there is a joint between two solid wood members 24. Such a joint may e.g. function as a dilation joint. Such dilatation joint may separate the two solid wood members by a gap or they may be abutted but having no or may be only partially interconnection by glue on the abutted surfaces. The same type of configuration forming a dilatation joint may be present on the upper lip 50 and on the tongue 56. Each lip/tongue may have more than one dilatation joint.

FIGS. 3 and 6 illustrate a set of structural panels 10 wherein a surface of the tongue 56 of the second locking member 32″ and a surface of the lower lip 52 of the first locking member 31′ both lie in a plane defined by an interface between two layers of the common laminate of layers. In this case said interface is the interface between the second and third layers, as counted from the bottom in the figure.

FIGS. 3 and 6 illustrate a set of structural panels 10 wherein a surface of the tongue 56 of the second locking member 32″ and a surface of the upper lip 50 of the first locking member 31 both lie in a plane defined by an interface between two layers of the common laminate of layers. In this case said interface is the interface between the second and third layers, as counted from the top in the figure.

As illustrated in FIG. 3-5 the tongue 56 of the second locking member 32″ may comprise an upper locking surface 62 and a lower locking surface 63. In the figures the upper locking surface 62, when in contact with the upper lip 50 in the locked disposition 41, prevents the second structural panel 10″ from moving upwards relative to the first structural panel 10′, i.e. the upper locking surface 62 may be seen as part of the vertical lock of the mechanical locking system. In the figures the lower locking surface 63, when in contact with the lower lip 52 in the locked disposition 41, prevents the second structural panel 10″ from moving downwards relative to the first structural panel 10′, i.e. the lower locking surface 63 may be seen as part of the vertical lock of the mechanical locking system. In FIG. 4-5, the upper 62 and lower 63 locking surfaces are partially offset with respect to each other in a direction within the aligned planes XY1/XY2 of the first 10′ and second 10″ structural panels. In FIG. 3, the upper 62 and lower 63 locking surfaces are fully offset, beyond the upper vertical contact plane 96, with respect to each other in a direction within the aligned planes XY1/XY2 of the first 10′ and second 10″ structural panels.

As illustrated in FIGS. 3-4, The upper locking surface 62 may extend between an upper outer contact point 93 and an upper inner contact point 94. The upper outer contact point 93 is the contact point between the first and second locking member on the upper locking surface 62 that is closest to the center of the first structural panel. The upper inner contact point 94 is the contact point between the first and second locking member on the upper locking surface 62 that is closest to the center of the second structural panel. Similarly, the lower locking surface 63 may comprise a lower outer contact point 95, being the contact point between the first and second locking member on the lower locking surface 63 that is closest to the center of the first structural panel. Similarly, the lower locking surface 63 may comprise a lower inner contact point 97, being the contact point between the first and second locking member on the lower locking surface 63 that is closest to the center of the second structural panel.

Further, the upper lip may have a contact plane 96, wherein the contact plane 96 is orthogonal to the plane of the first structural panel and comprise the outermost contact point of the upper lip to the second locking member.

As illustrated in FIG. 3 the mechanical locking system 30 may be configured such that the lower outer contact point 95 is closer to the center of the second structural panel than the upper lip contact plane 96 is. This may be advantageous as it facilitates a tight vertical lock while still enabling easy assembly.

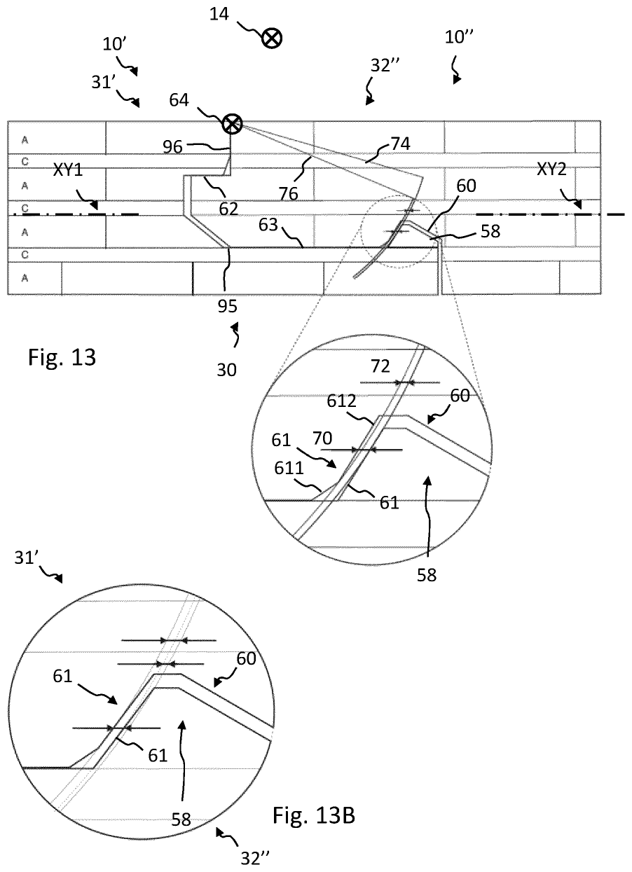

Alternatively, as seen in FIG. 13, the mechanical locking system 30 may be configured such that the lower outer contact point 95 and the upper lip contact plane 96 have the same distance to the center of the second structural panel.

Alternatively, the mechanical locking system 30 may be configured such that the lower outer contact point 95 is closer to the center of the second structural panel than the upper inner contact point 94 but further away from the center of the second structural panel than the upper lip contact plane 96.

Alternatively, as seen in FIG. 5, the mechanical locking system 30 may be configured such that the lower outer contact point 95 and the upper inner contact point 94 have the same distance to the center of the second structural panel.

Alternatively, as seen in FIG. 4, the mechanical locking system 30 may be configured such that the lower outer contact point 95 is closer to the center of the second structural panel than the upper outer contact point 93 but further away from the center of the second structural panel than the upper inner contact point 94 is. For example, the mechanical locking system 30 may be configured such that the lower outer contact point 95 is closer to the center of the second structural panel than the upper outer contact point 93 but further away from the center of the second structural panel than the upper inner contact point 94, as shown in FIG. 4.

As illustrated in FIG. 2-6 the first locking member 31′ may be configured such that a length of the lower lip 52, from the innermost part of the tongue groove 54 to the outermost part of the lower lip 52, is greater than a thickness of the first structural panel 10′. As also illustrated, the first locking member 31′ may be configured such that a distance that the lower lip 52 extends beyond the upper lip 50 is greater than a thickness of the first structural panel 10′. A sufficiently large locking play 70 (as discussed in conjunction with FIG. 13) and/or rotational play 72, preferably more than 2 mm, will allow for a lower lip 52 that is shorter than the thickness of the structural panel 10′. It may also be achieved by a third locking member 33, as illustrated in FIG. 11-12. In FIG. 31, the integrated lower lip 52 is shorter but the extra locking member provide an extension of the lower lip.

It should be understood that “a locking element 58 engaging a locking groove 60, wherein the locking element is a protrusion of the first locking member 31 and the locking groove 60 is a groove in the second locking member 32, or vice versa” may be implemented in many different ways, e.g. by:
(a) a truss connector plate 34 being held by one of the first 31 or second 32 locking members and having protruding metal teeth inserted into the other of the first 31 or second 32 locking member; and/or
(b) a block 38 being placed in an indentation 36 of the first 31 and/or second 32 locking member; and/or
(c) a ridge 37 of one of the first 31 and second 32 locking members being inserted in an indentation 36 of the other of the of the first 31 and second 32 locking members; and/or
(d) a cavity 39 being at least partially filled by a block 38 or a truss connector plate 34, the cavity 39 being a gap between a surface of the first 31 and second 32 locking members; and/or
(e) a tongue protrusion 65 being positioned in a positioning groove 67′, 67″ of the first 31 and/or second 32 locking member; and/or
(f) a protrusion 90 of one of the first 31 and second 32 locking members being inserted in a groove 91 of the other of the of the first 31 and second 32 locking members.

It should also be understood that a locking element may be configured to prevent both separating movements of the first 10′ and second 10″ structural panels in at least a direction orthogonal to the aligned planes of the first 10′ and second 10″ structural panels as well as separating movements of the first 10′ and second 10″ structural panels in a direction within the aligned planes of the first 10′ and second 10″.

The locking element may comprise wood. In this case, the locking element may, preferably, comprise wood fibers oriented in the locking direction. For example, locking element oriented along the edge direction comprise word fibers oriented along the edge direction. The fiber direction of the locking element may be oriented perpendicular to the locking direction.

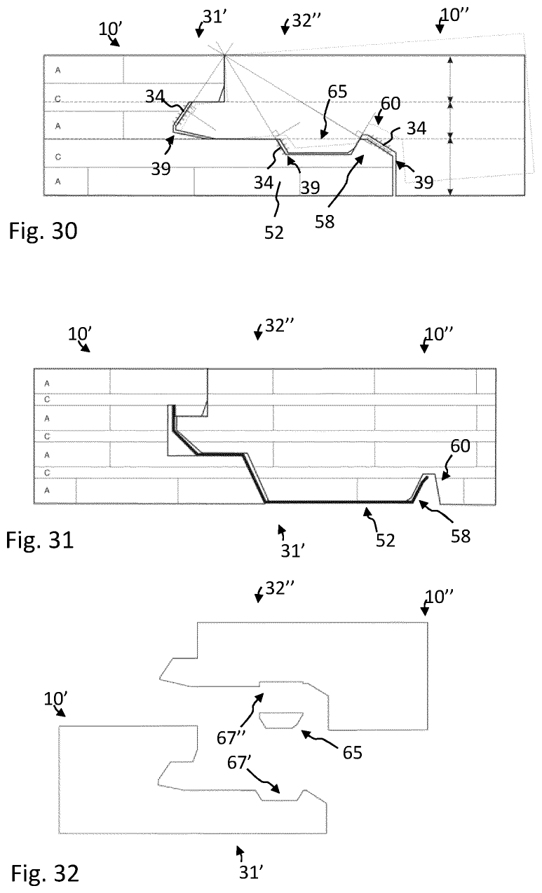

Going back to FIGS. 3 and 6, the surface on the lower lip is in these figures a C-layer. It may comprise a polymer layer, such as glue, on top of the layer, partially or completely covering the locking surface 62. The polymer layer may act as a friction member. The polymer layer may act as a third locking member. The polymer layer may lock both orthogonally to the edge direction and along the edge direction. The locking surface 62 of the tongue is in these figures an A-layer. It may also comprise a polymer layer. The polymer layers may induce a press fit between the tongue and the tongue groove. The press fit being a result of the tongue being thicker than the tongue groove in the normal direction to the panel top surface. The polymer layer may be present in all embodiments comprising locking surfaces between the first and second locking member in interfaces between two layers of the common laminate layer. For example, also FIGS. 13 and 30.

The press fit may also be obtained by milling the tongue thickness greater between upper contact surface 62 and the lower contact surface 63 than the locking groove opening between said contact surfaces. The lower contact surface 63 may comprise deviating angles on the tongue 56 relative the lower lip 52 on the complementary lower contact surfaces 63. With angles that makes the surfaces meet, there may be a vertical press fit closer to the locking element and a looser press fit or complementary fit or even a play between the contact surfaces closer to the lower outer contact point 95.

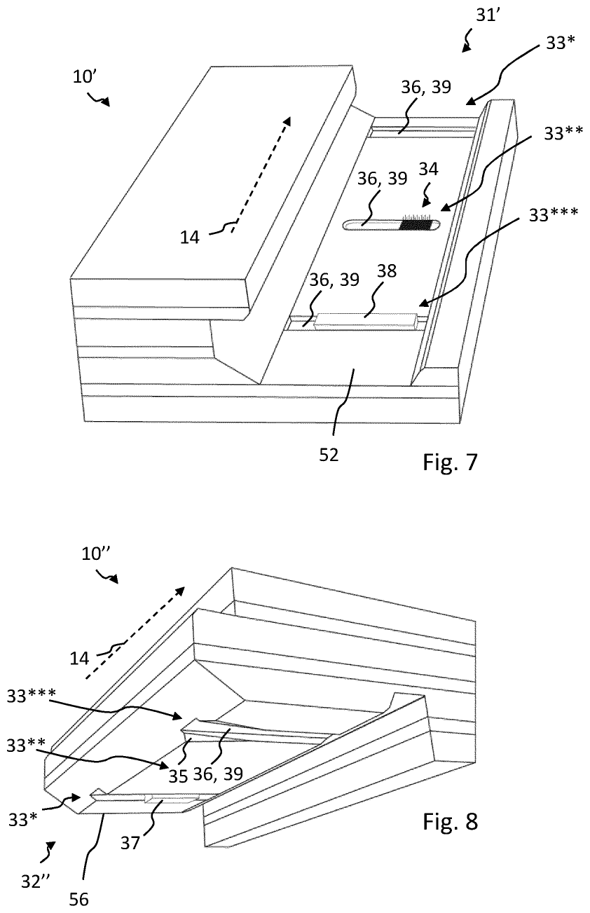

The mechanical locking system 30 may comprise a third locking member 33 configured to, in the locked disposition 41 of the mechanical locking system 30, resist a shear force. Thus, the third locking member 33 may prevent the first 10′ and second 10″ structural panels from sliding relative to each other along the edge direction 14. FIG. 7 illustrates a first locking member 31′ of a first structural panel 10′ and FIG. 8 illustrates a second locking member 32″ of a second structural panel 10″, together forming a mechanical locking system 30. Three types of third locking members are illustrated 33*, 33**, and 33***. It should be understood that a mechanical locking system 30 may comprise several different types of third locking members at the same time or one type alone.

The first type of third locking member 33* illustrated comprises an indentation 36, such as a groove or recess, in the lower lip 52 of the first locking member 31′ and a ridge 37 on the tongue 56 of the second locking member 32″. The ridge 37 and indentation 36 are configured such that the ridge 37 enters the indentation 36 by the rotational movement. The ridge 37 and indentation 36 are further configured such that in the locked disposition 41 the ridge 37 and indentation 36 interlock such that the ridge 37 is prevented from moving in the edge direction 14 by the indentation 36 and vice versa. Guiding chamfers 35 guide the panels longitudinaly relative each other at the first contact surfaces during positioning panel 10′ and 10″ in angled position relative each other. Example of guiding chamfers 35 is illustrated in FIG. 8 The guiding chamfers 35 on the lower contact surface 63 is preferably positioned in conjunction to the lower outer contact point 95 at the tongue 56. They may extend the entire length of the block, ridge and or groove. It should be understood that one or more guiding chamfers 35 may be arranged anywhere on the first 31 or second 32 locking member, e.g. on a groove extending along the edge 12 of the first 31 or second 32 locking member or on a on a groove extending orthogonal to the edge 12 of the first 31 or second 32 locking member. Alternatively, there may be a guiding chamfer 35 on a hole which is part of the mechanical locking system (30), the hole may e.g. chamfered hole configured to receive a chamfered locking element such as a conical protrusion. Thus the conical shape of the hole may be considered to be a guiding chamfer 35. The guiding surface 611 for the horizontal lock may guide horizontally. The guiding chamfer 35 may guide longitudinally. The guiding chamfer and/or the guiding surface may extend from a common surface of the locking element.

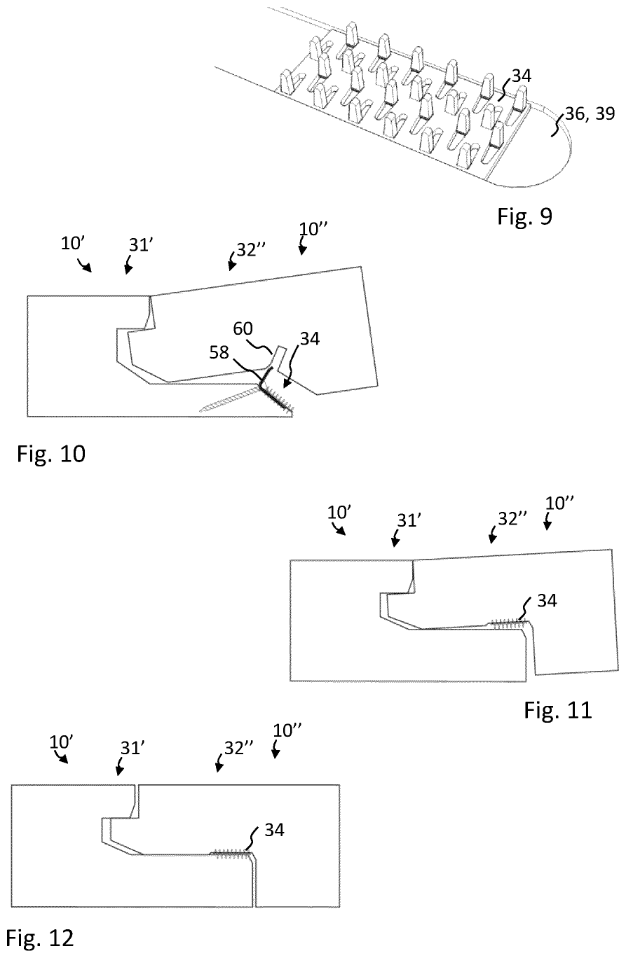

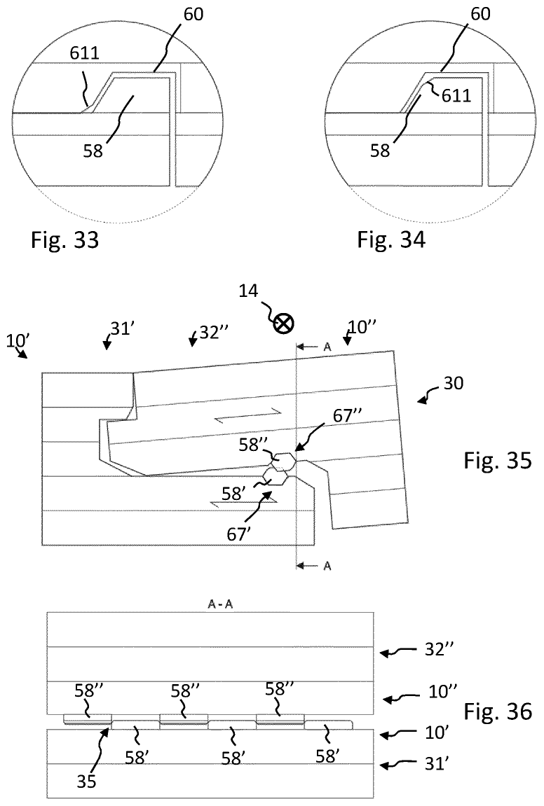

The second type of third locking member 33** illustrated comprises a truss connector plate 34 placed in an indentation 36, such as a groove or recess, in the lower lip 52 of the first locking member 31′. A more detailed view of a truss connector plate 34 placed in an indentation 36 is shown in FIG. 9. The illustrated truss connector plate 34 is a metal plate with protruding metal teeth. In this embodiment, the metal teeth protrude in one direction from the metal plate of the truss connector plate 34. In other embodiments the teeth may extend in opposite directions from the metal plate as illustrated in FIGS. 11 and 39. As seen in FIG. 7 the metal teeth protrude out of the indentation 36. The mechanical locking system 30 is configured such that the truss connector plate 34, placed in the indentation 36, inserts the protruding metal teeth into the second locking member 32″ by the rotational movement. As illustrated in FIGS. 7 and 9 the indentation may be configured such that the truss connector plate 34 is prevented, by the side walls of the indentation, from moving along the edge direction 14. As illustrated in FIGS. 7 and 9 the indentation may be configured such that the truss connector plate 34 can move in another direction within the indentation 36. Thus, the truss connector plate 34 may slide within the indentation 36 in said other direction as the mechanical locking system 30 moves into the locked disposition 30. This may facilitate the metal teeth being inserted properly in a locking member 31, 32. In the locked disposition 41 the truss connector plate 34 is connected to the second locking member 32″ by the metal teeth. Thus, the metal plate of the truss connector plate 34, in the indentation 36, prevents the first 10′ and second 10″ locking members from moving relative to each other along the edge direction 14. The truss connector plate 34 is preferably positioned close to the locking element 58, with its teeth spaced from the tongue 56 of the second locking member 32″ when the second locking member 32″ has entered into angled engagement with the first locking member 31′ and when the guiding surfaces 611 FIG. 33/34, or locking surface 61 in absence of guiding surface, of the locking element 58 and the locking groove 60 are only partially opposite each other. The length and position of the teeth of the truss plates in FIG. 30 may also be configured such that they can be spaced from the surface into which they will penetrate in the interlocked disposition when the second locking member has entered into rotational engagement of the first locking member but not yet into the interlocked disposition.

The third type of third locking member 33*** illustrated comprises an indentation 36, such as a groove or recess, in the lower lip 52 of the first locking member 31′ and an indentation 36, such as a groove or recess, in the tongue 56 of the second locking member 32″. It further comprises a separate block 38 which can be placed in the indentation 36 in the lower lip 52 such that the rotational movement inserts the block 38 also into the indentation 36 in the tongue 56. Thus, the first 31′ and second 32″ locking members interlock by the block 38 in the respective indentations 36.

All three types of third locking members 33*/33**/33*** illustrated are configured to be obscured from sight by the first 10′ and second 10″ structural panels when the mechanical locking system 30 is in the locked disposition.

For two of the illustrated types of third locking members 33**/33*** illustrated the mechanical locking system 30 is configured to form a cavity 39 between the first 31′ and second 32″ locking member when the mechanical locking system 30 is in the locked disposition 41, the cavity 39 herein being formed by the indentation 36. For these types the third locking members 33**/33*** is a unit separate from the first 10′ and second 10″ structural panel. For third locking member 33** the separate unit is the truss connector plate 34. For third locking member 33*** the separate unit is the block 38.

All three types of third locking members 33*/33**/33*** illustrated may allow the panels to move perpendicular to the edge direction 14 if the locking system is provided with locking play 70 (as described in conjunction with FIG. 13). While preventing from substantial movement, the ridge/block/third locking member may be thinner in the edge direction 14 than the indention to allow limited movements in the edge direction. For example, climate movements of less than 5 mm, preferably less than 2 mm.

It should be understood that the truss connector plate 34 may be configured to resist other forces and movements than shear forces.

In a first example, FIG. 10 illustrates that the truss connector plate 34 may comprise a locking element 58 configured to be inserted in a locking groove 60 by the rotational movement.

The locking element 58 of the truss connector plate 34 may be part of the metal plate of the truss connector plate 34, shaped to protrude out from the surface on which the truss connector plate 34 is placed on. In FIG. 10 the truss connector plate 34 is connected to the first locking member 31′, in this case by being screwed to the first locking member 31′. Thus, in the locked disposition the truss connector plate 34 may form part of a horizontal lock of the mechanical locking system 30. A separating movement in a direction within the aligned planes of the first 10′ and second 10″ structural panels, e.g. within the aligned planes and orthogonal to the edge direction 14, may thus be prevented by the locking element 58 of the truss connector plate 34 and the locking groove 60. Thus, the truss connector plate 34 may resist both shear forces and function as a horizontal lock of the mechanical locking system 30.

In a second example, FIGS. 11 and 12 illustrates that the metal teeth of the truss connector plate 34 may prevent a separating movement in a direction within the aligned planes of the first 10′ and second 10″ structural panels, e.g. within the aligned planes and orthogonal to the edge direction 14. FIG. 11 illustrates a set of structural panels 10 with the mechanical locking system 30 in the unlocked disposition 40 and FIG. 12 illustrates the same set of structural panels 10 with the mechanical locking system 30 in the locked disposition 41. Once again, a separating movement in a direction within the aligned planes of the first 10′ and second 10″ structural panels, e.g. within the aligned planes and orthogonal to the edge direction 14, is prevented by the truss connector plate 34. Thus, the truss connector plate 34 may resist both shear forces and function as a horizontal lock of the mechanical locking system 30. The structural panels 10 will, due to insertion of the oppositely directed teeth in both panels in the angled position as illustrated in FIG. 11, take a relative position in the locked disposition 41 illustrated in FIG. 12 with a defined climate compression gap in the contact plane 96. The gap is created since the truss connector plate 34 is positioned on a surface in the locking system geometry that is at an angle in relation a straight line passing through the contact axis 64, as opposed to how the truss connector plates 34 are positioned aligned with said line in FIG. 30. Said surface is preferably parallel with the top surface of the panel. The gap is permanent or semi-permanent. It may be configured to be sufficiently weak to be closed by pushing the structural panels 10 together with force that alter the truss connector plate 34 or the wood in the insertion point, e.g. induced by swelling of the panels due to changes in relative humidity. The third locking member 33 that provide a well defined climate compression gap can be combined with a locking element 58 that provide a locking strength that will not bear away for climate movements loads. In all embodiments with oppositely directed teeth truss connector plate, these may also be replaced by a single or multiple set of nails tipped at both ends.

It should be understood that other third locking members 33 than the ones described above may be used. For example, glue may be used as a third locking members 33 in all embodiments. Uncured glue may be provided on the first 31 or second 32 locking member before interlocking them. Once the glue has cured, the glue may function as a third locking members 33. In all embodiments describing a third locking member, these may in part comprise or in whole be replaced with a resilient polymeric material such as polyurethane, natural or synthetic rubber such as EPDM. When replacing glue as locking member, a sufficient space, thinner than the thickness of the resilient member is formed between the first and second locking member. Preferably providing a gap or indention between the tongue 56 and the lower lip 52 on the lower vertical locking surface 63. It may preferably be combined with a resilient member also on the upper vertical locking surface 62.

The third locking member 33 may comprise wood. In this case, the wood fiber direction of the third locking member may be different from the wood fiber direction of the structural laminate of layer that the third locking member 33 is positioned on.

FIG. 30 illustrates that the cavity 39 may not necessarily be an indentation 36. Alternatively, the cavity 39 may be a gap between a surface of the first locking member 31′ and the second locking member 32″, e.g. a gap extending along the entire length of the aligned edges of the first 10′ and second 10″ structural panels. The cavity 39 may fully or partially be filled by the third locking member 33. FIG. 30 illustrates three different truss connector plates 34 in three different cavities 39. The three truss connector plates 34 may be connected to the first 31′ or second 32″ locking member before placing in the locked disposition 41′. For example, the truss connector plates 34 may be double sided truss connector plates 34 wherein one side is manually hammered into one of the first 21′ or second 32″ locking member before placing in the locked disposition 41′. The mechanical locking system 30 may advantageously be configured to squeeze the truss connector plate 34 between the first 21′ or second 32″ locking members. The gap forming the cavity 39 may be a gap between a locking element 58 and a locking groove 60, see e.g. the cavity 39 to the right in FIG. 30. The gap forming the cavity 39 may be a gap between a tongue protrusion 65 and the lower lip 52, see the cavity 39 in the middle in FIG. 30. The interconnected locking system may comprise a space between the lower side of the protrusion 65 and lower lip 52. The tongue 56 may preferably be thinner between the upper vertical locking surface 62 and the lower vertical locking surface 63 than the upper lip 50. The upper lip 50 may preferably be thinner than the lower lip 52. The mechanical locking system 30 may be configured such that the tongue protrusion 65 is inserted in a corresponding recess in the lower lip 52 by the rotational movement. The locking element 58 may extend vertically up to or below above the lower vertical locking surface 62. The protrusion 65 may extend vertically below the lower vertical locking surface. There may be a gap or no gap below the protrusion 65 and the lower lip 52.

FIG. 30 further illustrates that the first 31′ and second 32″ locking element may have complementary surfaces, the complementary surfaces having a tangent going through the rotational axis 64 or the contact axis 64. In the figure the complementary surfaces are surfaces of the cavity 39. The teeth of the truss plate are preferably perpendicular to the complementary surfaces. There is a space between the majority of the teeth tips and the panel in which they shall engage when the locking element enters the locking groove during the rotational movement. Preferably all teeth have a space.

Dashed lines in FIG. 30 illustrate the structural panels 10 during the rotational movement. The locking system may be provided with one, two or all three different truss plates. There may be a single truss plate in two interlocked panels. There may be several truss plates along the interlocked edge. The truss plate may be mounted on the first locking member before installation. The truss plate may be mounted on the second locking member before installation. The teeth may be flat in shape. They may be curved, e.g. half pipe shaped. The flat or curved surface may face the rotational axis. A tangent to the surface may be at an angle to the rotational axis, more than 90 degree.

FIGS. 30 and 31 illustrate that the respective first 31′ and second 32″ locking element may not necessarily need to be shaped out of one single piece of the load bearing laminate of layers 20. There may be parts of the first 31′ or second 32″ locking element that are put in place after shaping, e.g. through milling, the load bearing laminate of layers 20. For example, FIG. 31 illustrates that the lower lip 52 and the locking element 58 may be part of a strip, e.g. a metal strip, that may be connected to the first structural panel 10′ after milling the rest of the first locking member 31′. As another example, FIG. 32 illustrates that the tongue protrusion 65 may be manufactured as a separate part and connected to the second structural panel 10″ after milling the rest of the second locking member 32″.

The locking element 58 65 may be positioned in a positioning groove 67. The positioning groove 67 may be a positioning groove 67′ milled in the lower lip or a positioning groove 67″ milled in the tongue. The groove is precisely aligned with the contact plane 96. At least one side wall of the guiding groove guides a protruding flange of the locking element member to a precise distance relative the contact plane 96. At least one side wall of the groove interact with at least one flange to transfer horizontal load in the locking system.

The horizontal load may also be transferred by the separate locking element member from its fixing members such as glue or screw.

The separate tongue protrusion 65 may be connected to the second locking member 32″, preferably in a positioning groove.

The separate tongue protrusion 65 may be connected to the first locking member 31″, preferably in a positioning groove. It will then serve as an upwardly extending locking element 58. The positioning groove of the second locking member 32″ will consequently constitute a locking groove.

The separate tongue protrusion 65 may be loosely positioned in the first locking member 31″, preferably in a positioning groove. It may be positioned during the installation process.

The separate tongue protrusion 65 may be continuous along the edge, but more preferably discontinuous. At least a first segment may be positioned in conjunction to a first end along the edge direction 14 of the panel. A second segment may be positioned at a second opposite end of the panel along the edge direction 14. A third segment may be positioned between the first and second segments, preferably in the middle.

FIGS. 35 and 36, illustrate the use of a first plurality of locking elements 58′ and a second plurality of locking elements 58″ with a mechanical locking system 30.

FIG. 35 illustrates a side view of a first 10′ and second 10″ structural panel. FIG. 36 illustrates a cross-sectional view of said structural panels, the cross-section being along the line A-A indicated in FIG. 35.

As seen in the figures: the mechanical locking system 30 may comprise:
a first plurality of locking elements 58′, the locking elements of the first plurality of locking elements 58′ being spaced apart and arranged along the edge 12 of the first structural panel 10′; and
a second plurality of locking elements 58″, the locking elements of the second plurality of locking elements 58″ being spaced apart and arranged along the edge 12 of the second structural panel 10″.

The mechanical locking system 30 may be configured to, by the rotational movement going from the unlocked disposition 40 to the locked disposition 41, insert a locking element of the first plurality of locking elements 58′ into a space between two locking elements of the second plurality of locking elements 58″. The locking elements of the first plurality of locking elements 58′ may comprise any kind of protrusions of the first structural panel 10′, e.g. protrusions from a lip of the first locking member. The locking elements of the second plurality of locking elements 58″ may comprise any kind of protrusions of the second structural panel 10″, e.g. protrusions from the tongue of the second locking member. The first plurality of locking elements 58′ may be arranged in a row in the edge direction 14 of the first structural panel 10′, as seen in the figures. The second plurality of locking elements 58″ may be arranged in a row in the edge direction 14 of the second structural panel 10″, as seen in the figures. Thus, spaces between locking elements of the first plurality of locking elements 58′ may be seen as locking grooves for the locking elements of the second plurality of locking elements 58″, and vice versa.

The first plurality of locking elements 58′ and/or the second plurality of locking elements 58″ may comprise one or more guiding chamfer 35, as illustrated in FIG. 36. Said guiding chamfers 35 may comprise one or more rounded or slanted corners of the first plurality of locking elements 58′ and/or the second plurality of locking elements 58″.

The first plurality of locking elements 58′ may be positioned in a positioning groove 67′ of the first locking member 31′. The second plurality of locking elements 58″ may be positioned in a positioning groove 67″ of the second locking member 32″. This is illustrated in FIG. 35. Thus, first plurality of locking elements 58′ and/or the second plurality of locking elements 58″ may be implemented analogously to FIG. 32. For example, a positioning groove 67′ may be milled into the first locking member 31′ and the first plurality of locking elements 58′ may be glued into said positioning groove 67′. Similarly, a positioning groove 67″ may be milled into the second locking member 32″ and the second plurality of locking elements 58″ may be glued into said positioning groove 67″.

The plurality of locking elements may be integrally formed in the structural laminate of layers and or they may be of separate material. The first plurality of locking elements may be provided in a first groove in the first panel. The second plurality of locking elements may be provided in a second locking groove in the second panel. The first plurality of locking elements may during installation be inserted into the second locking groove and may then prevent movements of the interconnected first and second interconnected panel in the longitudinal direction of the locking groove and in a perpendicular direction to the locking groove.

FIG. 13 illustrates a rotational play 72 between a first 31′ and second 32″ locking member. The first locking member 31′ and the second locking member 32″ each comprises a contact axis 64 which in the figure overlap. The figure illustrates the mechanical locking system 30 in the locked disposition 41. If the first 10′ and second 10″ structural panels are pulled from each other, in a direction within the aligned planes XY1/XY2 and orthogonal to the edge directions 14, a locking surface 61 of the locking groove 60 of the second locking member 32″ will come in contact with a locking surface 61 of the locking element 58 of the first locking member 31′ and prevent the separating movement.

The figure illustrates the minimum rotational radius 74 of the first locking member 31′, i.e. the smallest distance between the contact axis 64 of the first locking member 31′ and the locking surface 61 of the locking element 58 of the first locking member 31′, measured in a direction orthogonal to the contact axis 64 of the first locking member 31′. Further, the figure illustrates the maximum rotational radius 76 of the second locking member 32″, i.e. the largest distance between the contact axis 64 of the second locking member 32 and the locking surface 61 of the locking groove 60 of the second locking member 32″, measured in a direction orthogonal to the contact axis 64 of the second locking member 32″. In the figure the minimum rotational radius 74 of the first locking member 31′ is larger than the maximum rotational radius 76 of the second locking member 32″. Thus, the rotational play 72, i.e. the minimum rotational radius 74 of the first locking member 31′ minus the maximum rotational radius 76 of the second locking member 32″, is positive. A rotational play 72 may be larger than 0 mm or between 0 mm and 5 mm. Alternatively, the rotational play 72 may be negative, while the risk of damaging the locking surfaces is apparent. It is then preferable to provide the locking element 58 and preferably also the locking groove 60 at least partially or in whole in C-layers. It is in such case advantageous to make the locking element or the locking groove in a reinforcement segment. From a milling perspective it is preferable that the upmost part of the locking element 58 is an A-layer.

FIG. 13 further illustrates that the locking element 58 may engage the locking groove 60 in the angled position to guide the edges towards each other during the rotational movement.

FIG. 13 further illustrates that the upper surface of the locking element may be angled having a tangent that may pass close or through the rotational axis 64. A gap 39 is provided between the locking groove and the upper surface. This may hold a truss plate illustrated in FIG. 30.

FIG. 13 further illustrates that the horizontal locking surface 61 of the locking groove 60 may be provided with two locking angles. A first lower locking angle providing a guiding surface 611. The guiding surface 611 may serve as an initial contact surface against the locking element during rotational locking. A second locking surface 612, with a second locking angle that is more inclined or having a higher locking angle than the first locking angle, may be the primary locking surface that lock against the locking element 58 in the locked disposition. FIG. 33 also illustrates a guiding surface 611 in the locking groove 60.

A guiding surface 611 may also be provided on the locking element 58, as illustrated in FIG. 34. The less inclined surface is positioned above the primary locking surface. The locking angle of the primary locking surfaces of the locking element and the locking groove is preferably parallel. If there is provided guiding surfaces on both the locking element and the locking groove, then these two surfaces may preferably be parallel.

The first locking surfaces 611 may be partially or in whole positioned in a different layer than parts of or the whole surface of the second locking surface 612 as illustrated in FIG. 5, in the locking element or the locking groove.

FIG. 13 further illustrates a locking play 70 between a first 31′ and second 32″ locking member. The locking play 70 is a play between the first 31 and second 32 locking members when the mechanical locking system 30 is in the locked disposition 41. Thus, the locking play 70 is the distance the first 31 and second 32 locking members can move relative to each other in a direction within the aligned planes XY1/XY2 and orthogonal to the edge directions 14.

The rotational play 72 may be larger than the locking play 70.

FIG. 13 further illustrates that the upper vertical locking surface 62 may be located inside a layer, e.g. an A-layer or a C-layer, and the lower vertical locking surface 63 may be at least partially located in the interface between two layers.

The inset of FIG. 13 illustrates an over-angled mechanical locking system, wherein the first and second locking members are configured such that:

in the locked disposition, parts of said locking surface of the second locking member which have the maximum rotational radius of the second locking member are closer to the lower side of the interlocked structural panels than parts of said locking surface of the first locking member which have the minimum rotational radius of the first locking member.

FIG. 13B illustrates an under-angled mechanical locking system, wherein the first and second locking members are configured such that:
in the locked disposition, parts of said locking surface of the second locking member which have the maximum rotational radius of the second locking member are further away from the lower side of the interlocked structural panels than parts of said locking surface of the first locking member which have the minimum rotational radius of the first locking member.

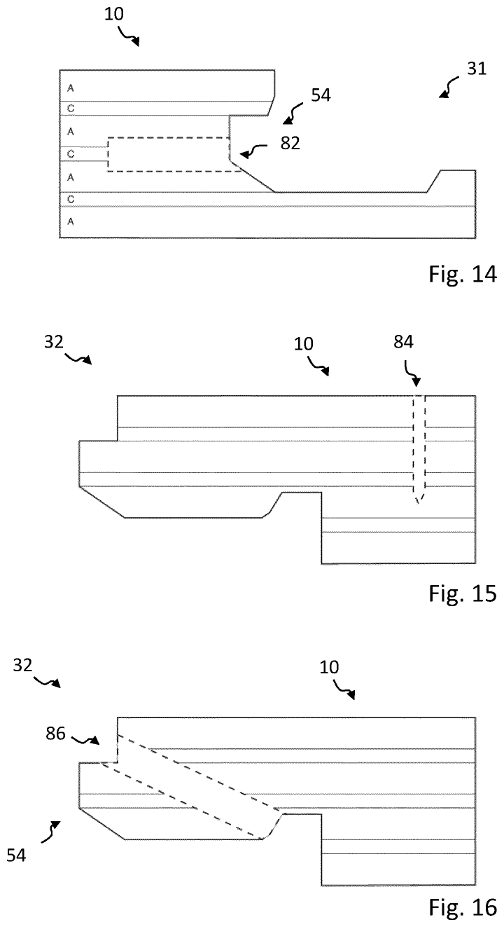

FIG. 14-16 illustrate structural panels 10 comprising attachments 80, wherein the attachment 80 is configured such that the structural panel 10 can be attached to a lifting arrangement 81 and lifted by the lifting arrangement 81.

FIG. 14 illustrates an attachment 80 in the form of a recess 82 into a locking member, in this case a first locking member 31. The illustrated recess 82 is a recess at the innermost part of the tongue groove 54. The recess is configured to receive a hook for lifting the structural panel 10.

FIG. 15 illustrates an attachment 80 in the form of a hole 84 into a locking member, in this case a second locking member 32.

FIG. 16 illustrates an attachment 80 in the form of a hole 86 through a part of a locking member, in this case through the tongue 56 of a second locking member 32. It may exit in the locking groove or the contact surface. It may enter below the uppermost contact point between the first and second member. It may be obscured from sight in the locked disposition.

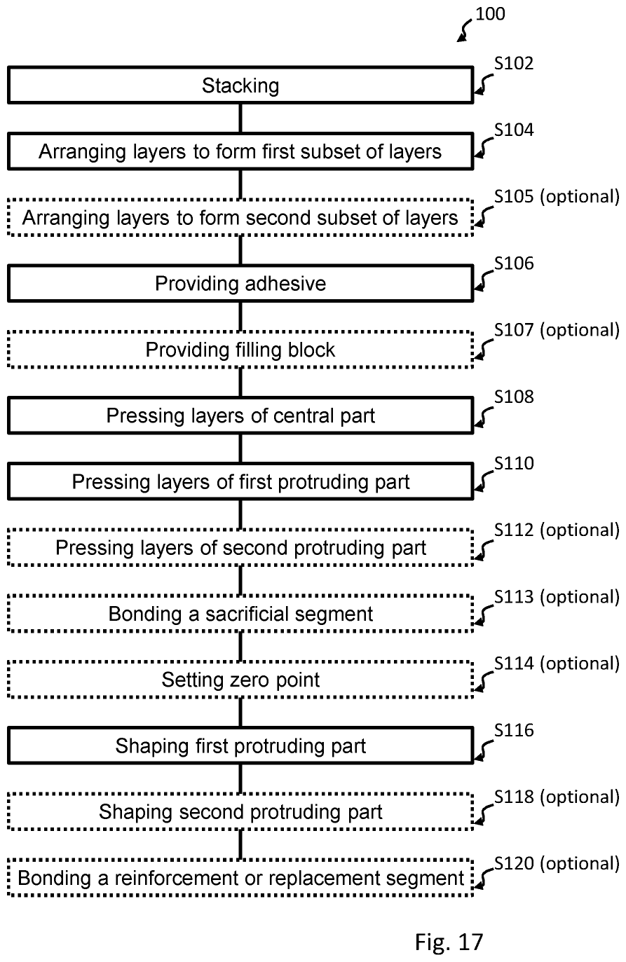

FIG. 17 illustrates a flow chart of a method 100 for constructing a panel. The method 100 is herein mainly described as a method for constructing a structural panel 10, in particular the structural panels discussed in conjunction with the first aspect. However, it should be understood that the method 100 may alternatively be used for constructing other structural panels. For example, the method 100, or at least parts of the method 100, may be used for constructing structural panels with non-rotational mechanical locking systems such as the ones described in conjunction with FIG. 29. It should also be understood that the method 100 may be used to construct other panels than structural panels 10. For example, a laminate floor panel for a floating floor may be constructed.

The method 100 is herein described as comprising the steps S102-S120. However, it should be understood that some of the steps are optional, as indicated in the figure. It should be understood that at least some of the steps may be performed in a different order than indicated in the figure, as readily understood by the skilled person.

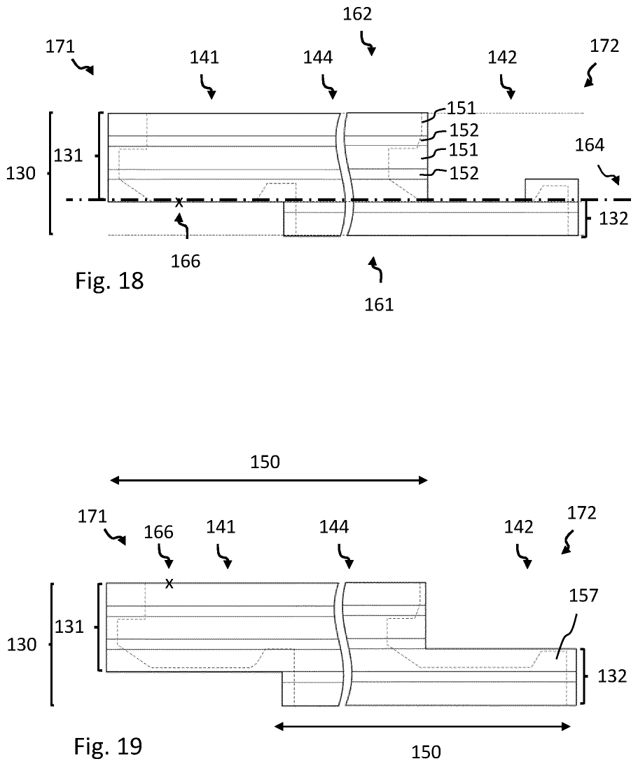

According to the method 100 a set of layers 130 are stacked S102 in a direction from a lower side 161 to an upper side 162. FIG. 18-19 illustrates how the set of layers 130 may be stacked S102.

Further, layers of the set of layers 130 are arranged S104 such that a first subset of layers 131 protrudes beyond at least part of remaining layers of the stacked set of layers 130 at a first edge 171 of the stacked set of layers 130. The layers may be arranged S104 during the stacking S102, e.g. by placing the first subset of layers 131 with an offset compared to the remaining layers during the stacking S102. Alternatively, the layers may be arranged S104 after the stacking S102. For example, the layers may be stacked S102 in an aligned manner and after the stacking S102 some layers may be shifted to protrude and thereby form the first subset of layers 131.

Optionally, layers of the set of layers 130 may be arranged S105 such that a second subset of layers 132 protrudes beyond at least part of remaining layers of the stacked set of layers 130 at a second edge 172 of the stacked set of layers 130. Again, arranging S105 the second subset of layers 132 may be done during or after the stacking S102.

FIG. 18-19 illustrates the set of layers 130 stacked S102 and arranged S104, S105 to form a first 131 and a second 132 subset of layers. The figures illustrate that the stacked set of layers 130 form a first protruding part 141 comprising the first subset of layers 131 and a second protruding part 142 comprising the second subset of layers 132. In between the first 141 and second 142 protruding part there is a central part 144 comprising all layers of the stacked set of layers 130. For illustrative purposes most of the central part 144 has been excluded from the figures.

Further, adhesive is provided S106 between each layer of the stacked set of layers 130. This may be done during the stacking S102. For example, after placing a layer in the stack adhesive may be provided to the top side of the layer before the next layer is placed. Adhesive may be provided also between lumberboards within a layer.

Further, an uppermost layer of the central part 144 of the stacked set of layers 130 and a lowermost layer of the central part 144 of the stacked set of layers 130 are pressed S108 towards each other, to bond the layers of the central part 144 of the stacked set of layers 130 together.

Further, an uppermost layer of the first protruding part 141 of the stacked set of layers 130 and a lowermost layer of the first protruding part 141 of the stacked set of layers 130 are pressed S110 towards each other, to bond the layers of the first protruding part 141 of the stacked set of layers 130 together.

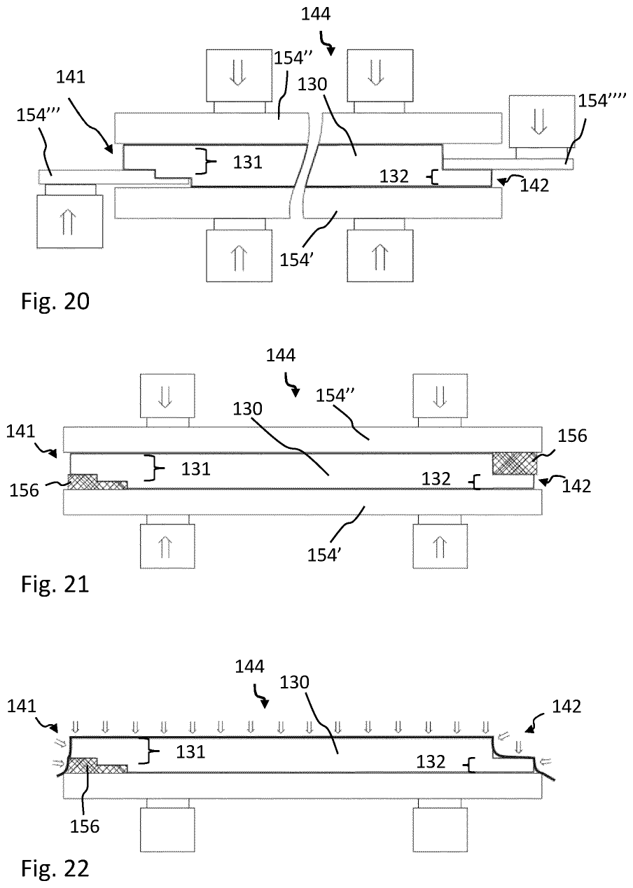

Optionally, an uppermost layer of the second protruding part 142 of the stacked set of layers 130 and a lowermost layer of the second protruding part 142 of the stacked set of layers 130 may be pressed S112 towards each other, to bond the layers of the second protruding part 142 of the stacked set of layers 130 together. One layer within the first 141 and the second 142 protruding part may be offset further than a second layer within said parts, as illustrated on the first protruding part 141 in FIG. 20-22.

The layers of the stacked set of layers 130 may comprise wooden layers. For example, all layers of the stacked set of layers 130 may be wooden layers. As illustrated in FIG. 18, the stacked set of layers 130 may comprise at least a first 151 and a second 152 wooden layer, the first wooden layer 151 having a wood fiber direction orthogonal to a wood fiber direction of the second wooden layer 152. The stacked set of layers 130 may comprise solid wood members 24. The first wooden layer 151 may comprise solid wood members 24, such as lumber boards, arranged side by side in parallel. The second wooden layer 152 may comprise solid wood members 24, such as lumber boards, arranged side by side in parallel. A single layer may comprise a single or several solid wood members side by side arranged in orthogonal direction to a neighboring layer comprising several solid wood members side by side, both layers within the first or the second protruding part 141, 142.

The layers of the stacked set of layers 130 are bonded together by pressing. An uppermost layer of the central part 144 of the stacked set of layers 130 and a lowermost layer of the central part 144 of the stacked set of layers 130 are pressed S108 towards each other, to bond the layers of the central part 144 of the stacked set of layers 130 together. An uppermost layer of the first protruding part 141 of the stacked set of layers 130 and a lowermost layer of the first protruding part 141 of the stacked set of layers 130 are pressed S110 towards each other, to bond the layers of the first protruding part 141 of the stacked set of layers 130 together. Optionally, an uppermost layer of the second protruding part 142 of the stacked set of layers 130 and a lowermost layer of the second protruding part 142 of the stacked set of layers 130 may be pressed S112 towards each other, to bond the layers of the second protruding part 142 of the stacked set of layers 130 together. The press operations may be performed simultaneously or as separate press steps.

FIG. 20-22 illustrate three different ways to press S108, S110, S112 layers together. Press members 154 may be used. Press members 154 may be flat surfaces between which the layers to be pressed are sandwiched. At least one press member may be movable.

FIG. 20 illustrates a stacked set of layers 130 with a first 141 and second 142 protruding part. A first 154′, second 154″, third 154″ and fourth 154″ press member is used for pressing. In the figure, an uppermost and a lowermost layer of the central part 144 are pressed S108 towards each other by the first 154′ and second 154″ press members. In the figure, an uppermost and a lowermost layer of the first protruding part 141 are pressed S110 towards each other by the third 154′″ and second 154″ press members. In the figure, an uppermost and a lowermost layer of the second protruding part 142 are pressed S112 towards each other by the first 154′ and fourth 154″ press members.

FIG. 21 illustrates that a filling block 156 may be provided S107 for pressing S110, S112 a protruding part. In the figure the filling block 156 at the first protruding part 141 fills the entire void between the first press member 154′ and the first protruding part 141 and transfers force from the first press member 154′ to the lowermost layer of the first protruding part 141. Thus the protrusion is pressed via the filling block 156. However, it should be understood that the entire void may not necessarily need to be filled. As long as the filling block 156 is in contact with a press member 154 (in this case the first press member 154′) and a layer of a protruding part (in this case the lowermost layer of the first protruding part 141 the filling block 156 may fill a void and thereby transfer force. In the figure the filling block 156 at the second protruding part 142 fills the entire void between the second press member 154″ and the second protruding part 142 and transfers force from the second press member 154″ to the uppermost layer of the second protruding part 142. The filling block 156 at the second protruding part 142 may function analogously to the filling block 156 at the first protruding part 141. FIG. 21 illustrates that the filling block is slightly thicker in the pressing direction compared to the void it is filling. The filling block is preferably of resilient material, such as polyurethane, natural or synthetic rubber such as EPDM, and may be compressed such that contact and pressure is also transferred in the central part 144 by the press members 154′ and 154″.

FIG. 22 illustrates that a vacuum press may be used for pressing S108, S110, S112 a central part or a protruding part. The vacuum press may be used together with a filling block 156 as seen at the first protruding part 141 or without a filling block 156 as seen at the second protruding part 142. The press member 153″, 153″ and the filling block 16 may be used to arrange and offset the layers. The members or filling block are then pressing sideways to displace the layers to an offset position. It is however preferred that the filling block 156 is already positioned when stacking the layer that is offset in relation to previous layers.

The adhesive is applied between each layer stacking. It may be provided glue/adhesive also on the filling block, which may be provided with nonstick surface or a sacrificial segment 167, such as wood veneer or paper, which adhere to the layers.

The first protruding part 141 of the stacked set of layers 130 may be shaped S116 to form a locking member of the first protruding part 141, the locking member of the first protruding part 141 being configured to interlock the structural panel with another structural panel.

Optionally, the second protruding part 142 of the stacked set of layers 130 may be shaped S118 to form a locking member of the second protruding part 142, the locking member of the second protruding part 142 being configured to interlock the structural panel with another structural panel.

FIG. 18-19 illustrate, by dashed lines, how the first 141 and second 142 protruding part may be shaped to form a first 31 and second 32 locking member in accordance with the above description. Thus, a protruding part may be shaped to form a locking member which interlocks by a rotational movement. However, it should be understood that a protruding part may be shaped to form other types of locking members, e.g. a locking member which does not necessarily interlock by a rotational movement. A protruding part may be shaped to form a locking member of a non-rotational mechanical locking system such as a protrusion 90 or groove 91 similar to those shown in FIG. 29. It should also be understood that locking members such as a protrusion 90 or groove 91 similar to those shown in FIG. 29 may not necessarily need to be shaped. After pressing S108, S110, S112 layers together, a locking member such as a protrusion 90 or groove 91 similar to those shown in FIG. 29 may be ready and one or all of the shaping steps S116, S118 may be omitted.

The shaping S116, S118 may be performed by milling. A zero point 166 may be set S114 for the milling machine before shaping a locking member. In principle the zero point 166 may be set anywhere. However, it may be advantageous to set the zero point 166 in the vicinity of the locking member to be shaped.

The set S114 zero point 166 may be a point in a plane 164 comprising an interface between the first subset of layers 131 and the remaining layers of the stacked set of layers 130, as illustrated in FIG. 18. Said point may be a point on the first protruding part 141.

The set S114 zero point 166 set may be a point on an outer surface of the stacked set of layers 130, wherein the outer surface lies on the, upper or lower, side of the stacked set of layers 130 that is closest to the interface between the first subset of layers 131 and the remaining layers of the stacked set of layers 130, as illustrated in FIG. 19. Said point may be a point on the first protruding part 141. It is extra advantageous when a vertical locking surface 162, 163 is at least partially positioned in the plane of said interface. The locking members may be shaped step by step be several milling tools. The panel is pressed against a support at the zero point 166, at each milling tool position. Each support being carefully aligned.

FIG. 19 illustrates that the first subset of layers 131 and the second subset of layers 132 may both comprise at least one common layer 157 of the stacked set of layers 130.

FIG. 19 further illustrates that at least one layer in the first subset of layers 131 and at least one layer in the second subset of layers 132 may have a common width 150, the common width 150 being a width in a direction orthogonal to the first 171 and second 172 edges. In the figure the two bottom layers and the four top layers all have a common width 150. In the figure, the common layer 157 has a width larger than the common width 150. It is preferable that the common layer is an A-layer.

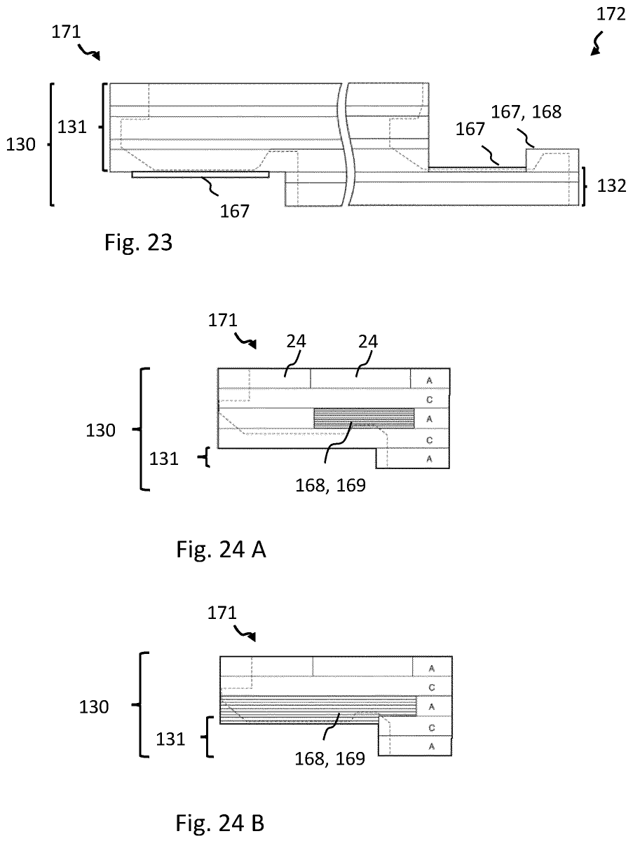

FIG. 23 illustrates that a sacrificial segment 167 may be bonded S113 to the first 141 or second 142 protruding part of the stacked set of layers 130. For example, as illustrated, when the first 131 and second 132 subset of layers are next to each other, a sacrificial segment 167 may be bonded to a layer of the first subset of layers 131 that interfaces a layer of the second subset of layers 132. Similarly, a sacrificial segment 167 may be bonded to a layer of the second subset of layers 132 that interfaces a layer of the first subset of layers 131. Part of the sacrificial segment 167 may then be removed during shaping S116, S118.

FIGS. 24A and B illustrates that a replacement segment 169 may be bonded S120 to the first 141 or second 142 protruding part of the stacked set of layers 130. The replacement segment 169 replaces part of a layer of the first 141 or second 142 protruding part of the stacked set of layers 130. In FIG. 24 A the replacement segment 169, of plywood, replaces part of one single layer. However, it should be understood that in some cases the replacement segment 169 may replace part of one layer as well as part of another layer, as illustrated in FIG. 24 B where one replacement segment replaces part of an A-layer as well as part of a C-layer. The replacement segment 169, or part of the replacement segment 169 may also be a reinforcement segment 168, i.e. a segment having greater hardness, and/or greater ductility, than the majority of layers comprised in the stacked set of layers 130, wherein the reinforcement segment 168 form at least part of the locking member of the first 141 or second 142 protruding part. The reinforcement segment 168 may e.g. comprise a harder and/or more ductile type of wood than the majority of layers comprised in the stacked set of layers 130. A reinforcement segment 168 does not necessarily need to be a replacement segment 169. A reinforcement segment 168 may e.g. be a segment bonded to a layer of the first 141 or second 142 protruding part without replacing any part of a layer. For example, a strip of wood, e.g. a hard type of wood, may be bonded to a protruding part and then shaped into a locking element 58. The reinforcement segment 168 may be used to form various parts of a first locking member 31, e.g. a locking element 58 (as mentioned), and/or a lower lip 52, and/or a upper lip 50, and/or a tongue groove 54. It may be particularly advantageous to use a reinforcement segment 168 for the locking element 58. The reinforcement segment 168 may be used to form various parts of a second locking member 32, e.g. a tongue 56 or part of a tongue 56, and/or a locking groove 60. It may be particularly advantageous to use a reinforcement segment 168 for the locking groove 60. It may be used to balance a lip 50,52 or the tongue 56. For example, if the lip comprises only two orthogonal wood layers, it may become unbalanced. By adhering a reinforcement layer with its fibers mainly orthogonally oriented to a layer of the lip, that will make the lip comprise two layers of the same fiber direction spaced by a middle layer with orthogonally oriented fibers.

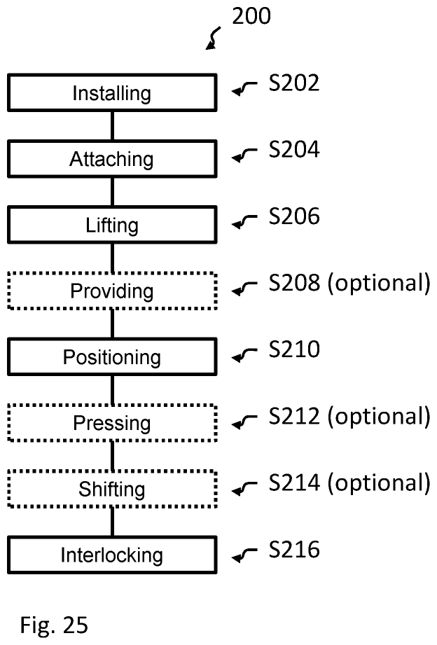

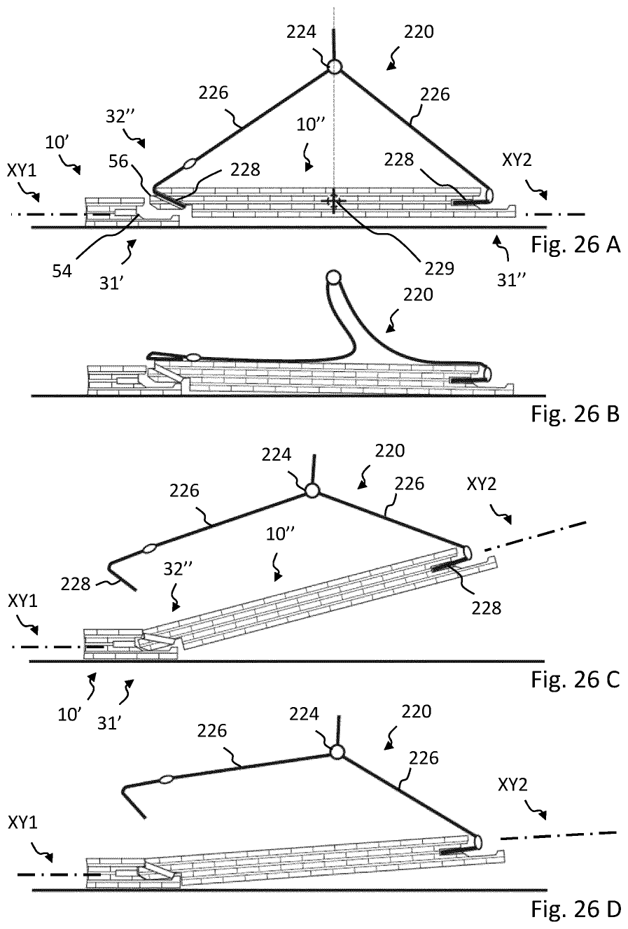

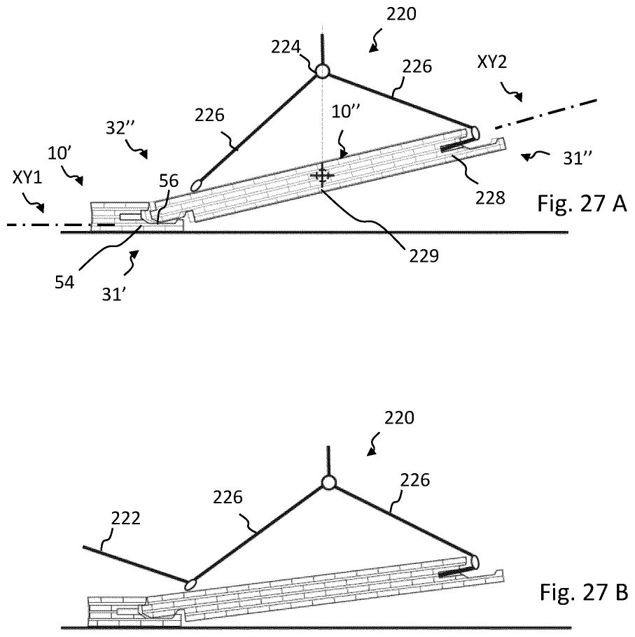

FIG. 25 illustrates a flow chart of a method 200 for assembling a structural member of a building out of a set of structural panels. Two different ways of performing the method 200 are illustrated in the time series illustrated in FIG. 26 and FIG. 27 respectively. FIG. 26 illustrates that first and second locking members may be put in contact with each other at an angle. FIG. 27 illustrates that first and second locking members may be put in contact with each other while not being at an angle. The method 200 is herein described as assembling a structural member out of a first 10′ and second 10″ structural panel, wherein the first 10′ and second 10″ structural panel are the structural panels discussed in conjunction with the first aspect. However, it should be understood that the method 200, or at least parts of the method 200, may be performed on other structural panels.

The method 200 is herein described as comprising the steps S202-S116. However, it should be understood that some of the steps are optional, as indicated in the figure. It should be understood that at least some of the steps may be performed in a different order than indicated in the figure, as readily understood by the skilled person.

In FIG. 26 and FIG. 27 the method 200 the structural member of a building is a floor. However, it may alternatively be another structural member, such as a wall.

According to the method 200 the first structural panel 10′ is installed S202 in the building. For example, in the case of assembling a floor, as illustrated in FIG. 26-27, a first structural panel 10′ may be placed on supporting beams. A lifting arrangement 220 is attached S204 to the second structural panel 10″.

The second structural panel 10″ is then lifted S206 by the lifting arrangement 220. The first locking member 31′ of the first structural panel 10′ may then be brought into contact with the second locking member 32″ of the second structural panel 10″. Further, the second structural panel 10″ is positioned S210, by the lifting arrangement 220, relative to the first structural panel 10′ such that the first 31′ and second 32″ locking members are in contact, with the plane XY2 of the second structural panel 10″ at an angle to the plane XY1 of the first structural panel 10′ and the second structural panel 10″ rotationally movable in relation to the first structural panel 10′.

The lifting arrangement 220 may comprise one or more resilient elongated member 226 such as a rope, wire or rod. The lifting arrangement 220 may be lifted in a lifting point 224, by a crane or similar lifting machine. The lifting arrangement may be attached in another end to the second structural panel 10″, e.g. to an attachment of the second structural panel 10″. In FIGS. 26 and 27 the second structural panel 10″ comprises a second locking member 32″ at the edge being interlocked to the first structural panel 10′ and a first locking member 31″ at the opposite edge. In FIG. 26 the second locking member 32″ comprises a hole 86 through the tongue 56 of the second locking member 32″. The hole 86 is configured to receive a strap laced through the hole 86 for lifting the panel. There could be two holes 86 close to each other and the strap can be laced down into one hole 86 passing under the tongue 56 then returning through the second hole 86 to the entrance surface. The holes 86 can be pointing towards each other on the underside of the tongue or they can be parallel.

A hole 86 may alternatively receive a commonly known bolt shaped clamping means that expand in the hole when lifted. Same as used for attachment 84 in FIG. 15. A hole 86 may alternatively, as illustrated here, receive a hook 228 for lifting the panel. The hook 228 is herein attached to a resilient elongated member 226 of the lifting arrangement 220. In FIG. 27 there is a different attachment at the second locking member 32″. The resilient elongated member 226 may e.g. be attached by a bolt in a hole 84. Further, in FIGS. 26 and 27 there is a recess 82 into the first locking member 31″ of the second structural panel 10″. A hook 228 in the recess 82 contributes to lifting the second structural panel 10″.

The second structural panel 10″ may be lifted S206 with the plane XY2 of the second structural panel 10″ parallel to the plane XY1 of the first structural panel 10′, as illustrated in FIG. 26A. The first 31′ and second 32″ locking members may then be put in contact with the planes XY1, XY2 still being essentially parallel, as illustrated in FIG. 26 B. One or more resilient elongated members 226 of the lifting arrangement 220 may subsequently be released from the structural panel, e.g. resilient elongated members 226 at the edge to be interlocked, as further illustrated in FIG. 26 B. FIG. 26 C illustrates that the second structural panel 10″ may once more be lifted S206. The second structural panel 10″ may herein be lifted only at one edge, in this case at the edge opposite to the edge to be interlocked. A reverse rotational movement of the second structural panel 10″ may then be performed, placing the second structural panel 10″ at an angle to the first structural panel 10′, again illustrated in FIG. 26 C. During the reverse rotational movement, the tongue 56 of the second locking member 32″ may slip into the tongue groove 54 of the first locking member 31′ and the mechanical locking system 30 may be put in the unlocked disposition 41. Thereby, the second structural panel 10″ is positioned S210 relative to the first structural panel 10′ in contact between the first 31′ and second 32″ locking members, with the plane XY2 of the second structural panel 10″ at an angle to the plane XY1 of the first structural panel 10′ and the second structural panel 10″ rotationally movable in relation to the first structural panel 10′. Thus, In FIG. 26 the positioning S210 is done by the lifting arrangement 220, by lifting S206 in the edge opposite to the edge to be interlocked. The first 31′ and second 32″ locking member is then interlocked S216, by moving the lifting arrangement 220 to perform the rotational movement of the second structural panel 10″ in relation to the first structural panel 10′. In FIG. 26 D the lifting point 224 is closer to the plane of the first structural panel 10′ than it was in FIG. 26 C. As seen in FIGS. 26 C and D such a movement of the lifting arrangement 220 may cause the second structural panel 10″ to pivot around a contact axis between the first 31′ and second 32″ locking members until the locked disposition 40 is reached.

The second structural panel 10″ may be lifted S206 with the plane XY2 of the second structural panel 10″ at an angle to the plane XY1 of the first structural panel 10′, as illustrated in FIG. 27A. The first 31′ and second 32″ locking members may then be put in contact with the planes XY1, XY2 at an angle to each other, as further illustrated in FIG. 27A. As seen in this figure the mechanical locking system 30 may be put in the unlocked disposition 41 immediately at contact between the first 31′ and second 32″ locking members. Thereby, the second structural panel 10″ is positioned S210 relative to the first structural panel 10′ in contact between the first 31′ and second 32″ locking members, with the plane XY2 of the second structural panel 10″ at an angle to the plane XY1 of the first structural panel 10′ and the second structural panel 10″ rotationally movable in relation to the first structural panel 10′. Thus, In FIG. 27A the positioning S210 is done by the lifting arrangement 220, by lifting S206 the second structural panel 10″ angled with respect to the first structural panel 10′ and placing the first 31′ and second 32″ locking members on contact with each other afterwhich the angled panel is shifted towards the already installed panel in order to slide the tongue 56 into the tongue groove 54. The first 31′ and second 32″ locking member is then interlocked S216, by moving the lifting arrangement 220 to perform the rotational movement of the second structural panel 10″ in relation to the first structural panel 10′. FIG. 27 B illustrates once more how a rotational movement may be performed by moving the lifting arrangement 220 towards the plane XY1 of the first structural panel 10′. It should be understood that the lifting arrangement 220 may not necessarily need to be moved towards the first structural panel 10′ to perform the rotational movement. A movement towards the plane XY1 of the first structural panel 10′, wherein the plane extends outside the first structural panel 10′, may be sufficient. Thus, the lifting arrangement 220 may be moved towards the first structural panel 10′ to insert the tongue 56 into the tongue groove 54 and then moved towards the plane XY1 of the first structural panel 10′ (downwards in the case of a floor panel) to perform the rotational movement.

The second structural panel 10″ may be pressed S212 against the first structural panel 10′, while moving the lifting arrangement 220 to perform the rotational movement of the second structural panel.

The second structural panel 10″ may be pressed S212 against the first structural panel 10′ by the lifting arrangement 220. For example, by moving the lifting arrangement 220 towards the first structural panel 10′. For example, the lifting arrangement 220 may simultaneously be moved towards the plane XY1 of the first structural panel (e.g. towards the horizontal plane if the first structural panel is installed horizontally) which may be performed by a crane and moved towards the first structural panel 10′ which may be performed by hand. Thereby, the rotational movement may be performed while the second structural panel 10″ is pressed S212 against the first structural panel 10′. Alternatively, the second structural panel 10″ may be pressed S212 against the first structural panel 10′ by the lifting arrangement 220 by the configuration of the lifting arrangement 220. For example, FIG. 26 C illustrates that the lifting arrangement 220 may be configured such that the force exerted on the second structural panel 10″ by the lifting arrangement 220 and the force exerted on the second structural panel 10″ by gravity gives rise to a force component pressing S212 the second structural panel 10″ against the first structural panel 10′. The force component is preferably increased as illustrated in FIG. 26C by holding or fixing the deattached lifting member 226 in a direction towards the installed panel, preferably further distanced from the remaining attachment point than when fixed in the panel. This results in an angle between the crane lifting direction and the remaining attached lifting member 226, which will make the deattached lifting member to exert an increased force pressing the angled panel towards the installed panel.

Alternatively, or additionally, a force transfer arrangement 222 may be attached to the second structural panel 10″. The force transfer arrangement 222 may comprise one or more resilient elongated member such as a pike pole, elongated hook, rope, wire or rod. For example, a force transfer arrangement 222 may be attached to the second structural panel 10″ in the vicinity of the second locking member 32″ and the second locking member 32″ may be pulled, e.g. pulled by hand force, towards the first locking member 31′ such that the second structural panel 10″ is pressed S212 against the first structural panel 10′. While said pressure is applied by the force transfer arrangement 222, the lifting arrangement 220 may perform the rotational movement. Such a situation is illustrated in FIG. 27 B. Alternatively, the force transfer arrangement 222 may be attached to the lifting arrangement 220.

The method 200 may further comprise, when the first 31′ and second 32″ locking members are in contact, shifting S214 the second structural panel 10″ relative to the first structural panel 10′. For example, the second structural panel 10″ may be shifted towards the first structural panel 10′, e.g. in the situation shown in FIGS. 27A and B. The dashed lines in FIG. 27A illustrates how the tongue 56 is inserted in the tongue groove 60 by shifting the second structural panel 10″ towards the first structural panel 10′.

The second structural panel 10″ may be shifted towards the first structural panel 10′ such that a tongue 56 of the second locking member 32″ enters, or moves further into, a tongue groove 54 of the first locking member 31′. Shifting S214 the second structural panel 10″ relative to the first structural panel 10′ may be performed before the rotational movement. Alternatively, or additionally, the shift may be performed during the rotational movement, e.g. continuously during the rotational movement or occasionally during the rotational movement. Shifting S214 the second structural panel 10″ relative to the first structural panel 10′ may be performed by the lifting arrangement 220 or by the force transfer arrangement 222.

FIGS. 26 and 27 illustrate that the method 200 may be performed using one type of attachment 80 at one edge and another type of attachment at the opposite edge. For example, as shown in FIG. 26 a recess 82 into a locking member at one edge and a hole 86 through a part of a locking member at the opposite edge.

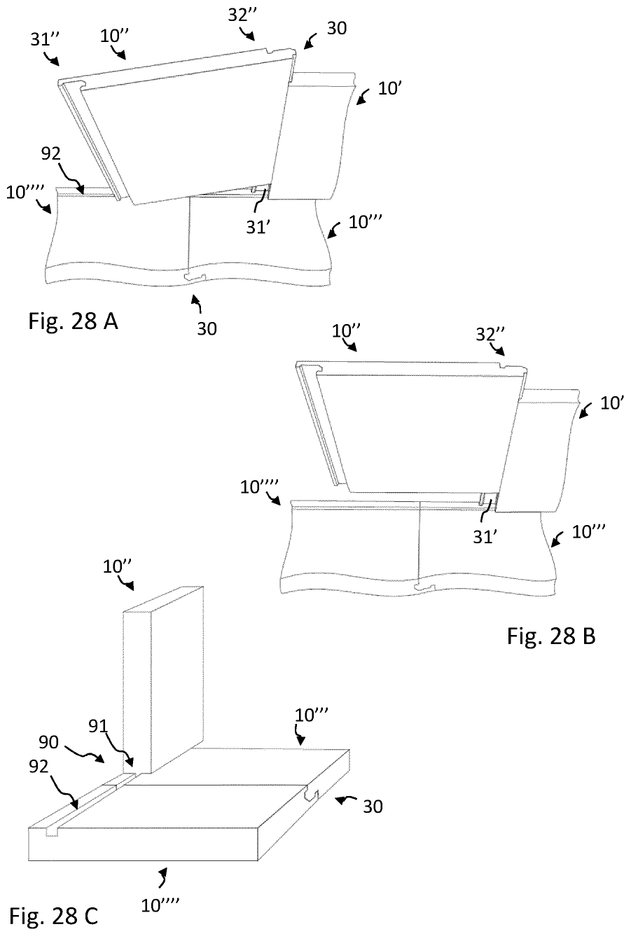

Alternatively, the second structural panel 10″ may be shifted in another direction than towards the first structural panel 10′, e.g. along the aligned edges of the first 10′ and second 10″ structural panels. Such a situation is illustrated in the time series of FIG. 28. As illustrated a structural panel may comprise other locking members than the first 31, second 32, or third 33 locking member. A structural panel may comprise a locking member 90 for connecting to an orthogonal structural panel. In FIG. 28 there are a first 10′ and a second 10″ structural panel forming a wall and a third 10′″ and a fourth 10″″ structural panel forming a floor. The third 10″ and a fourth 10″″ structural panels comprise a mechanical locking system 30 and have already been connected by putting said mechanical locking system 30 in the locked disposition. Further, the illustrated structural panels all comprise a locking member 90 for connecting to an orthogonal structural panel. Such a locking member 90 may comprise a groove 92. For example, as illustrated for the third 10′″ and a fourth 10″″ structural panels, a groove in a top surface of the structural panel. Such a locking member 90 may comprise a protrusion 91. For example, as illustrated for the second 10″ structural panel in FIG. 28 C, a protrusion 91 from a lateral side of the structural panel. As illustrated, the protrusion 91 may be at an edge orthogonal to the edges 12 of the first 31″ and second 32″ locking members. The protrusion 91 may be configured to fit in said groove 92. The time series of FIG. 28 illustrates that the second structural panel 10″ is connected to the first structural panel 10′, by placing the first 31′ and second 32″ locking members of the mechanical locking system 30 in contact and moving the mechanical locking system 30 into the locked disposition 41. This is illustrated in FIG. 28A-B. The rotational movement is performed with the first 10′ and a second 10″ structural panels offset with respect to each other, wherein the offset is along the edge corresponding to the first 31″ and second 32″ locking members. The structural panels are configured such that the protrusion 91 of the second structural panel 10″ align with a groove 92 of at least one structural panel orthogonal to the second structural panel 10″. Thus, at the position where the mechanical locking system 30 of the first 10′ and second 10″ structural panels have been put in the locked disposition 41 with an offset between the first 10′ and second 10″ structural panels (shown in FIG. 28 B) the second structural panel 10″ may be connected to the third structural panel 10′″ and/or the fourth structural panel 10″″ by shifting S214 the second structural panel 10″ relative to the first structural panel 10′ by the lifting arrangement 220. A schematic illustration of the structural panels after said shifting is illustrated in FIG. 28 C.

As illustrated in FIG. 28. C with the wall panel 10″ in cross cut view, it is clear that when the protrusion 91 enters both aligned grooves 92 of the interconnected flooring panels 10′″ and panel 10″″, that this will make the protrusion act as a third locking member 33 taking shear forces and preventing lateral movements between the floor panels. It should be understood from this example that the third locking member 33 may be inserted in abutting aligned grooves between two interconnected structural panels also from a visual surface of the panels, and can be obscured from sight by a third structural panel.

As previously mentioned, a third locking member 33 may be used when connecting a first 31 and second 32 locking member. As described in conjunction with FIGS. 7-12 a third locking member 33 may be provided S208 on the first 31 or second 32 locking member before interlocking the first 31 and second 32 locking member.

The lifting arrangement 220 discussed above may be configured to hold the plane of the second structural panel 10″ at an angle to a horizontal plane when the second structural panel 10″ is lifted by the lifting arrangement 220. Such a lifting arrangement 220 is illustrated in FIG. 27A. The illustrated lifting arrangement 220 can be seen as having a lifting point 224 which is in one horizontal direction vertically offset relative to the center of gravity 229 of the structural panel. The lifting arrangement 220 may further be configured such that when lifted at the lifting point 224, the center of gravity 229 and the lifting point 224 becomes vertically aligned holding the panel at an angle to the horizontal plane. The lifting arrangement 220 may comprise a resilient elongated member 226 configured to be attached to an attachment at an edge of the structural panel and a resilient elongated member 226 configured to be attached to an attachment at an opposite edge of the structural panel. The length of the resilient elongated members 226 and positions of the attachments may be configured such that when the structural panel is lifted, one of said two edges lies higher than the other. For example, assuming a symmetrical arrangement of attachments, the resilient elongated member 226 attached at the higher lying edge may be shorter than the resilient elongated member 226 attached at the lower lying edge. As illustrated in FIG. 27A the angle is adjusted such that the tongue 56 may freely enter the looking groove 54 and when the upper lip 52 and tongue 56 is in contact at the upper lip contact plane 96 there is a space between the lower side of the tongue 56 and the locking element 58.

In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A set of structural panels comprising a first structural panel, a second structural panel and a mechanical locking system,
wherein each of the first and second structural panel:
is configured to contribute to the structural integrity of the building;
extend in a plane;
comprise an edge extending in an edge direction;
comprise a load bearing laminate of layers, the load bearing laminate of layers being a laminate of layers configured to bear at least part of a structural load of the building, the load bearing laminate of layers comprising wood;
wherein the mechanical locking system comprises:
a first locking member arranged at the edge of the first structural panel and comprising at least two layers of the load bearing laminate of layers of the first structural panel;
a second locking member arranged at the edge of the second structural panel and comprising at least two layers of the load bearing laminate of layers of the second structural panel;
wherein the mechanical locking system is configured to form:
an unlocked disposition, wherein the first and second locking members of the mechanical locking system are in contact, with the plane of the second structural panel being at an angle to the plane of the first structural panel and the second structural panel being rotationally movable in relation to the first structural panel;
a locked disposition, wherein the first and second locking members of the mechanical locking system are in contact, with the plane of the second structural panel being aligned to the plane of the first structural panel and the first and second locking members of the mechanical locking system being interlocked to prevent separating movements of the first and second structural panels in at least one direction orthogonal to the aligned planes of the first and second structural panels, and one direction within the aligned planes of the first and second structural panels,
wherein the mechanical locking system is configured to connect the first structural panel to the second structural panel by a rotational movement of the second structural panel in relation to the first structural panel, the rotational movement going from the unlocked disposition to the locked disposition.

2. The of structural panels according to claim 1, wherein the mechanical locking system comprises
a third locking member configured to, in the locked disposition of the mechanical locking system, resist a shear force,
wherein the shear force is a force acting to separate the first and second structural panel in a direction parallel to the edge directions of the edges of the first and second structural panels at which the respective first and second locking members are arranged.

3. The set of structural panels according to claim 2, wherein the third locking member is configured to be obscured from sight by the first and second structural panels when the mechanical locking system is in the locked disposition.

4. The set of structural panels according to claim 2, wherein the mechanical locking system is configured to form a cavity between the first and second locking member when the mechanical locking system is in the locked disposition and wherein the third locking member is a unit separate from the first and second structural panel and configured to, when placed in the cavity between the first and second locking member, prevent the first and second locking member from moving relative to each other along the direction parallel to the edge directions of the edges of the first and second structural panels at which the respective first and second locking members are arranged.

5. The set of structural panels according to claim 2 wherein the third locking member is a truss connector plate, being a metal plate with protruding metal teeth, wherein the truss connector plate is configured to, when the metal plate is placed on one of the first or second locking members, insert the protruding metal teeth into the other of the first or second locking member by the rotational movement of the second structural panel in relation to the first structural panel.

6. The set of structural panels according to claim 1, wherein at least one of the first and second structural panel comprises an attachment, wherein the attachment is configured such that the structural panel can be attached to a lifting arrangement and lifted by the lifting arrangement, the attachment being an attachment to a locking member and comprising at least one of:
a recess into the locking member, the recess being configured to receive a hook for lifting the structural panel by the hook in the recess;
a hole into the locking member, the hole being configured to receive a bolt for lifting the structural panel by the bolt in the hole;
a hole through a part of the locking member, the hole being configured to receive a strap laced through the hole for lifting the structural panel by the strap laced through the hole.

7. The set of structural panels according to claim 1,
wherein the first locking member comprises
an upper lip and a lower lip, being respective protrusions of the load bearing laminate of layers of the first structural panel at the edge of the first structural panel, in a direction orthogonal both to the normal of the plane of the first structural panel and to the edge direction of the first structural panel, the lower lip being arranged below the upper lip;
a tongue groove, being a recess into the load bearing laminate of layers of the first structural panel at the edge of the first structural panel, the tongue groove being arranged between the upper and lower lip,
wherein the second locking member comprises a tongue, the tongue being a protrusion of the load bearing laminate of layers of the second structural panel at the edge of the second structural panel, in a direction orthogonal both to the normal of the plane of the second structural panel and to the edge direction of the second structural panel,
wherein the second locking member is configured to insert at least part of said tongue into said tongue groove by the rotational movement of the second structural panel in relation to the first structural panel.

8. The set of structural panels according to claim 7, wherein, in the locked disposition, the load bearing laminate of layers of the first structural panel and the load bearing laminate of layers of the second structural panel align to form one common laminate of layers wherein each layer of the common laminate of layers extends in both the first and second structural panel, the common laminate of layers comprising at least one C-layer, the C-layer being a wooden layer with wood fiber direction orthogonal to the edges of the interlocked first and second locking members, wherein
at least one of the at least one C-layer is part of the upper lip of the first locking member but not part of the tongue of the second locking member; and/or
at least one of the at least one C-layers is part of the lower lip of the first locking member but not part of the tongue of the second locking member, and/or
at least one of the at least one C-layers is part of the tongue of the second locking member but not part of the upper or lower lips of the first locking member.

9. The set of structural panels according to claim 7, wherein at least one lip of the first locking member comprises at least two parallel solid wood members, within the same layer of the load bearing laminate of layers of the first structural panel, each solid wood member having a wood fiber direction parallel to the edge at which the first locking member is arranged.

10. The set of structural panels according to claim 7, wherein, in the locked disposition, the load bearing laminate of layers of the first structural panel and the load bearing laminate of layers of the second structural panel align to form one common laminate of layers wherein each layer of the common laminate of layers extends in both the first and second structural panel,
wherein, in the locked disposition,
a surface of the tongue of the second locking member and a surface of the lower lip of the first locking member both lie in a plane defined by an interface between two layers of the common laminate of layers, and/or
a surface of the tongue of the second locking member and a surface of the upper lip of the first locking member both lie in a plane defined by an interface between two layers of the common laminate of layers.

11. The set of structural panels according to claim 7, wherein the tongue of the second locking member comprises:
an upper locking surface configured to, when in contact with the upper lip of the first locking member, prevent separating movements of the first and second structural panels in at least one direction orthogonal to the aligned planes of the first and second structural panels; and
a lower locking surface configured to, when in contact with the lower lip of the first locking member, prevent separating movements of the first and second structural panels in at least one direction orthogonal to the aligned planes of the first and second structural panels, wherein the upper and lower locking surfaces are, at least partially, offset with respect to each other in a direction within the aligned planes of the first and second structural panels.

12. The set of structural panels according to claim 7,
wherein the locking element of the first locking member and the locking groove of the second locking member each comprises a locking surface, wherein the locking surfaces of the of the first locking member and of the second locking member are surfaces configured to, when in contact with each other, prevent a separating movement of the first and second structural panels in a direction within the aligned planes of the first and second structural panels and orthogonal to the edge directions of the edges of the first and second structural panels at which the respective first and second locking members are arranged;
wherein the first locking member and the second locking member each comprises a contact axis, the contact axis being an axis along which the first and second locking members are in contact during the rotational movement and around which the rotational movement takes place;
wherein the first locking member has a minimum rotational radius, being a smallest distance between the contact axis of the first locking member and the locking surface of the locking element of the first locking member, measured in a direction orthogonal to the contact axis of the first locking member;
wherein the second locking member has a maximum rotational radius, being a largest distance between the contact axis of the second locking member and the locking surface of the locking groove of the second locking member, measured in a direction orthogonal to the contact axis of the second locking member;
wherein the first and second locking members are configured such that:
in the locked disposition, parts of said locking surface of the second locking member which have the maximum rotational radius of the second locking member are closer to a lower side of the interlocked structural panels than parts of said locking surface of the first locking member which have the minimum rotational radius of the first locking member, the lower side of the interlocked structural panels being a side comprising the lower lip; and
the minimum rotational radius of the first locking member is equal to or larger than the maximum rotational radius of the second locking member, whereby a rotational play, being a play between the first and second locking members during the rotational movement is equal to or larger than 0 mm.

13. The set of structural panels according to claim 12, wherein the first and second locking members are configured such that a difference between the minimum rotational radius of the first locking member and the maximum rotational radius of the second locking member is between 0 and 5 mm.

14-27. (canceled)
